(19) United States
(12) Patent Application Publication
(10) Pub. No.: US 2016/0351985 A1
(43) Pub. Date: Dec. 1, 2016

(54) LUMPED ELEMENT RECTANGULAR WAVEGUIDE FILTER

(71) Applicant: ESA EUROPEAN SPACE AGENCY, Paris Cedex 15 (FR)

(72) Inventor: Marco Guglielmi, Wassenaar (NL)

(73) Assignee: ESA European Space Agency, Paris Cedex 15 (FR)

(21) Appl. No.: 15/117,427

(22) PCT Filed: Feb. 10, 2014
(86) PCT No.: PCT/EP2014/052550

§ 371 Date: Aug. 8, 2016

(51) Int. Cl. H01P 1/208; H01P 7/06

(52) U.S. Cl. CPC H01P 1/208; H01P 7/06

(57) ABSTRACT

A resonator for use in a rectangular waveguide filter includes a first section of rectangular waveguide and a second section of rectangular waveguide that are arranged along a guide direction of the resonator and joined to each other to form the resonator. Walls of the second section of rectangular waveguide that extend in the guide direction are in a parallel relationship with respective walls of the first section of rectangular waveguide. A width of the first section of rectangular waveguide in a width direction is equal to a width of the second section of rectangular waveguide in the width direction so that the resonator has uniform width in the width direction. A height of the second section of rectangular waveguide in a height direction is smaller than a height of the first section of rectangular waveguide in the height direction.

### BACKGROUND

Technical Field

The present disclosure relates to a resonator for use in a rectangular waveguide filter, a group of resonators for use in a rectangular waveguide filter, and to a rectangular waveguide filter employing the resonator and/or the group of resonators.

The disclosure is particularly though not exclusively applicable to microwave filters in the front end of ground and satellite payloads for, e.g., telecommunication, radar, synthetic aperture radar (SAR), radiometers, radiolinks, etc.

Description of the Related Art

Microwave filters consisting of sections of rectangular waveguide (also referred to as microwave filters in rectangular waveguide) have been known for more than 50 years. In the most basic “in-line” implementation of such a microwave filter 100, as illustrated, e.g., in FIGS. 1A to 1C, rectangular cavity resonators 110, i.e., sections of rectangular waveguide having a length corresponding to half a wavelength, are coupled to each other with small sections 170 of rectangular waveguide below cut-off (inductive coupling windows) located in the input-output walls of each resonator. The series of sections of rectangular waveguide is interposed between an input port 160 and an output port 165. A discussion of such conventional inductive filters, which are commonly used in the front end of many different types of payloads, including telecommunication, radars, SAR, radiometers, radiolinks, etc., is provided in M. Guglielmi, A. Melcon, Novel Design Procedure for Microwave Filters, Proceedings of the 23^{rd} European Microwave Conference, 1993.

FIG. 1D illustrates the electrical performance of the filter 100 and FIG. 8A illustrates the out-of-band performance of the filter 100. As can be seen from these figures, the filter 100 is a fourth order filter (four pole filter) with a value for the maximum out-of-band rejection of about −60 dB.

For all payloads a reduction in size is a very important issue. This is especially the case for mobile applications and space applications, in which the available area of mounting space is severely limited and oftentimes has to be shared by multiple components.

In the prior art, numerous attempts towards miniaturization of microwave filters have been made. According to one implementation of a microwave filter 200 proposed by T. Shen, K. A. Zaki, Folded Evanescent-Mode Ridge Waveguide Bandpass Filters, 31st European Microwave Conference, 2001 that is illustrated in FIGS. 2A to 2C, sections of ridge waveguide (corrugated waveguide) 210 having inductive windows 270 are inserted into below cut-off rectangular waveguides interposed between an input port 260 and an output port 265. Such a microwave filter is typically referred to as ridge resonator filter.

FIG. 2D illustrates the electrical performance of the filter 200 and FIG. 8B illustrates the out-of-band performance of the filter 200. As can be seen from these figures, the filter 200 is a four pole filter with good out-of-band rejection, which is as good as −100 dB. On the other hand, it is found that insertion losses of the filter 200 are larger than the insertion losses of the inductive filter 100, and moreover, that the sustainable maximum power level of the filter 200 is about half that of the inductive filter 100. Moreover, due to the comparably complicated structure of the filter 200, it is rather difficult and costly to manufacture.

According to another implementation of the same concept, that has been proposed by M. Piloni, R. Ravanelli, M. Guglielmi, Resonant Aperture Filters in Rectangular Waveguide, 1999 IEEE MTT-S Digest, the section of ridge waveguide is replaced with a so-called resonant aperture that allows for a tuning element to be inserted in order to tune the filter.

Further, size reduction has also been shown in V. E. Boria, M. Bozzi, D. Camilleri, A. Coves, H. Esteban, B. Gimeno, M. Guglielmi, L. Polini, Contributions to the Analysis and Design of All-Inductive Filters with Dielectric Resonators, 33rd European Microwave Conference, Munich 2003 to be possible by using dielectric material to load the resonator cavities of microwave filters. Therein, dielectric loading of the resonator cavities is, e.g., achieved by providing a cylindrical column of dielectric material inside the rectangular resonator cavities. This solution however introduces significant complexity in manufacturing the microwave filter for the shaping and fixing of the cylindrical column of dielectric material inside the rectangular resonator cavities.

### BRIEF SUMMARY

The present disclosure provides a rectangular waveguide filter with reduced size. In various embodiments, the rectangular waveguide filter allows for simple and inexpensive manufacture. In various embodiments, the rectangular waveguide filter has a reduced size that allows for simple and inexpensive manufacture, without significantly deteriorating the electrical performance of the rectangular waveguide filter.

Accordingly, described herein is a resonator for use in a rectangular waveguide filter, a group of resonators for use in a rectangular waveguide filter, and a rectangular waveguide filter employing the resonator and/or the group of resonators, respectively having the features of the independent claims. Preferred embodiments are described in the dependent claims.

In the below summary, it is understood that a section of rectangular waveguide has a guide direction which defines a longitudinal direction of the section of rectangular waveguide. Conventionally, the z-axis of a coordinate system used to describe the section of rectangular waveguide is defined to extend along the longitudinal direction of the section of rectangular waveguide. Further, the (transverse) cross-section of the section of rectangular waveguide perpendicular to the longitudinal direction of the section of rectangular waveguide is referred to simply as the cross-section of the section of rectangular waveguide. An axis extending along the longitudinal direction and intersecting the cross-section in its center is referred to as the center axis of the section of rectangular waveguide.

Walls of the section of rectangular waveguide that extend in parallel to the longitudinal direction of the section of rectangular waveguide are referred to as the lateral walls of the section of rectangular waveguide, and walls that are perpendicular to the longitudinal direction are referred to as end walls. Lateral walls of the section of rectangular waveguide that correspond to broad sides (i.e., longer sides) of the cross-section are referred to as broad walls, or the top wall and the bottom wall of the section of rectangular waveguide. Conventionally, the x-axis of the coordinate system is defined to extend in parallel to the broad sides of the cross-section. In other words, the broad walls extend in a plane (referred to as the horizontal plane) spanned by the x-axis and the z-axis. Lateral walls of the section of rectangular waveguide that correspond to narrow sides (i.e., shorter sides) of the cross-section are referred to as narrow walls, or the side walls of the section of rectangular waveguide. Conventionally, the y-axis of the coordinate system is defined to extend in parallel to the narrow sides of the cross-section. In other words, the narrow walls extend in a plane spanned by the y-axis and the z-axis.

Further, a width direction of the section of rectangular waveguide is said to extend in parallel to the broad sides of the cross-section (i.e., along the x-axis), and a height direction of the section of rectangular waveguide is said to extend in parallel to the narrow sides of the cross-section (i.e., along the y-axis). In the section of rectangular waveguide as defined above, the electric field component E_{y} of the TE10 (TE₁₀) waveguide mode is oriented along the height direction, while the magnetic field component H_{z} of the TE10 mode is oriented along the guide direction, and the Hₓ component of the magnetic field of the TE10 mode is oriented along the width direction.

According to at least one aspect of the present disclosure, a resonator for use in a rectangular waveguide filter comprises a first section of rectangular waveguide and a second section of rectangular waveguide that are arranged along a guide direction of the resonator and joined to each other to form the resonator. Walls of the second section of rectangular waveguide that extend in the guide direction are in a parallel relationship with respective walls of the first section of rectangular waveguide, wherein a width of the first section of rectangular waveguide in a width direction is equal to a width of the second section of rectangular waveguide in the width direction so that the resonator has uniform width in the width direction, the width direction being defined by a broader one of dimensions of a transverse cross-section of the first section of rectangular waveguide. A height of the second section of rectangular waveguide in a height direction is smaller than a height of the first section of rectangular waveguide in the height direction, the height direction being defined by a narrower one of the dimensions of the transverse cross-section of the first section of rectangular waveguide. In the above, it is understood that the guide direction of the resonator corresponds to the guide direction of the first section of rectangular waveguide.

The above configuration represents a basic (single pole) resonator that may be used to build up a number of different passband filters in rectangular waveguide. As the present inventor has found out, building up passband filters in this manner results in a decrease of the length of the filters compared to comparable (i.e., equivalent) inductive filters. On the other hand, due to the simple structure of the above configuration, manufacture of such filters is significantly simpler than manufacture of equivalent ridge resonators. Since the resonator according to the above configuration is symmetric with respect to a symmetry plane extending along its guide direction and its height direction, various embodiments of the inventive resonator can be manufactured by the so-called clam-shell approach in which matching halves are manufactured and machined separately, and subsequently joined to form the desired resonator or microwave filter. This configuration is particularly convenient from an electrical performance point of view because the surface defined by the mating of the two halves is not cut by any electrical current. Furthermore, the clam-shell approach enables particularly simple and inexpensive manufacture of microwave filters. Accordingly, a microwave filter employing various embodiments of the inventive resonator can be manufactured in a particularly simple and inexpensive manner, and at the same time is shorter than an equivalent inductive microwave filter.

Further, if employed in a microwave filter, various embodiments of the inventive resonator result in a larger maximum bandwidth of the filter than would be achievable with an equivalent inductive filter, and in an improved out-of-band rejection compared to the equivalent inductive filter. At the same time, it turns out that the microwave filter employing various embodiments of the inventive resonator can withstand higher power levels than an equivalent ridge resonator filter, and has better insertion losses than the equivalent ridge resonator filter.

Preferably, the height of the second section of rectangular waveguide is between one fifth and one third of the height of the first section of rectangular waveguide. Further preferably, a length (i.e., electric length) of the second section of rectangular waveguide in the guide direction is equal to or larger than a length of the first section of rectangular waveguide in the guide direction.

It is of advantage if at least one of the first section of rectangular waveguide and the second section of rectangular waveguide is filled with a dielectric material.

Filling (or loading) the first section of rectangular waveguide and/or the second section of rectangular waveguide results in a further size reduction of the resonator, wherein the size reduction is proportional to the square root of the dielectric constant of the dielectric material used for loading.

The first and second sections of rectangular waveguide may be arranged relative to each other so that a center axis of the second section of rectangular waveguide and a center axis of the first section of rectangular waveguide are aligned with each other, each center axis extending along the guide direction of the respective section of rectangular waveguide.

The above configuration is symmetric with respect to a horizontal plane imaginarily cutting various embodiments of the inventive resonator in equal upper and lower halves. By virtue of the symmetry, manufacture of the resonator is further simplified.

Alternatively, the second section of rectangular waveguide may be arranged relative to the first section of rectangular waveguide so that a center axis of the second section of rectangular waveguide is shifted in the height direction relative to a center axis of the first section of rectangular waveguide, each center axis extending along the guide direction of the respective section of rectangular waveguide. Preferably, the height of the second section of rectangular waveguide is at most half the height of the first section of rectangular waveguide, and the center axis of the second section of rectangular waveguide is shifted in the height direction relative to the center axis of the first section of rectangular waveguide by at least half the height of the second section of rectangular waveguide. Further preferably, the height of the second section of rectangular waveguide is at most half the height of the first section of rectangular waveguide and one of lateral walls of the second section of rectangular waveguide that correspond to a broader one of dimensions of a transverse cross-section of the second section of rectangular waveguide is aligned with a respective one of lateral walls of the first section of rectangular waveguide that correspond to the broader one of dimensions of the transverse cross-section of the first section of rectangular waveguide. In other words, the top wall (bottom wall) of the second section of rectangular waveguide is aligned with the top wall (bottom wall) of the first section of rectangular waveguide.

Unlike the above configuration that displays symmetry with respect to a horizontal plane, the resonator according to the present configuration is not symmetric with respect to a horizontal plane. This asymmetry of the resonator enables construction of particularly short passband filters by rotating every other of the basic resonators by 180 degrees around an axis of rotation extending along the width direction of the respective basic resonator, thereby obtaining an “intertwined” configuration in which adjacent basic resonators are partially overlapping when seen along the height direction.

According to another aspect of the present disclosure, a group of resonators for use in a rectangular waveguide filter comprises a first resonator and a second resonator as defined above that are electromagnetically coupled to each other, wherein the guide directions of the first and second resonators are aligned with each other and the first resonator and the second resonator are arranged along the guide direction of the first resonator so that the second section of rectangular waveguide of the first resonator faces the second section of rectangular waveguide of the second resonator.

According to yet another aspect of the present disclosure, a group of resonators for use in a rectangular waveguide filter comprises a first resonator and a second resonator as defined above that are electromagnetically coupled to each other, wherein the guide directions of the first and second resonators are aligned with each other and the first resonator and the second resonator are arranged along the guide direction of the first resonator so that the first section of rectangular waveguide of the first resonator faces the first section of rectangular waveguide of the second resonator.

By the above configurations a two pole filter that is shorter than an equivalent inductive two pole filter can be provided. At the same time, this configuration allows for more simple a manufacture than that of an equivalent ridge resonator filter. The resulting two pole filter according to the inventive configuration has improved electrical performance compared to the ridge resonator filter as regards sustainable maximum power levels and insertion losses. Also, the resulting two pole filter has a larger maximum bandwidth and better out-of-band rejection than the equivalent inductive two pole filter.

According to another aspect of the present disclosure, a group of resonators for use in a rectangular waveguide filter comprises a first resonator and a second resonator as defined above. The guide directions of the first and second resonators are aligned with each other and the first resonator and the second resonator are arranged along a guide direction of the first resonator. The second resonator is rotated with respect to the first resonator by 180 degrees around a rotation axis extending in the width direction, wherein the second section of rectangular waveguide of the first resonator faces a part of the first section of rectangular waveguide of the second resonator and the second section of rectangular waveguide of the second resonator faces a part of the first section of rectangular waveguide of the first resonator. The second section of rectangular waveguide of the second resonator is electromagnetically coupled to the first section of rectangular waveguide of the first resonator and the second section of rectangular waveguide of the first resonator is electromagnetically coupled to the first section of rectangular waveguide of the second resonator.

In the above group of resonators, the first resonator and the second resonator may be further arranged so that, when seen in a viewing direction extending along the height direction, the second section of rectangular waveguide of the first resonator overlaps with the second section of rectangular waveguide of the second resonator.

By this configuration, even greater length reduction compared to an equivalent two pole inductive filter may be achieved, while the same advantages with regard to manufacturability and performance as described above can still be achieved. As it turns out, a two pole filter employing the inventive group of resonators according to the above configuration is also shorter than an equivalent ridge resonator filter.

According to another aspect of the present disclosure, a group of resonators for use in a rectangular waveguide filter comprises first through fourth resonators as defined above. The guide directions of the first through fourth resonators are aligned with each other and the first through fourth resonators are arranged along the guide direction of the first resonator so that the second section of rectangular waveguide of the first resonator faces the second section of rectangular waveguide of the second resonator. The first section of rectangular waveguide of the second resonator faces the first section of rectangular waveguide of the third resonator, and the second section of rectangular waveguide of the third resonator faces the second section of rectangular waveguide of the fourth resonator. The second section of rectangular waveguide of the first resonator is electromagnetically coupled to the second section of rectangular waveguide of the second resonator, the first section of rectangular waveguide of the second resonator is electromagnetically coupled to the first section of rectangular waveguide of the third resonator, and the second section of rectangular waveguide of the third resonator is electromagnetically coupled to the second section of rectangular waveguide of the fourth resonator.

By the above configuration a four pole filter that is shorter than an equivalent inductive four pole filter can be provided. At the same time this configuration allows for more simple a manufacture than that of an equivalent ridge resonator filter. The resulting four pole filter according to the inventive configuration has improved electrical performance compared to the ridge resonator filter as regards sustainable maximum power levels and insertion losses. Also, the resulting four pole filter has a larger maximum bandwidth and better out-of-band rejection than the equivalent inductive four pole filter.

According to another aspect of the present disclosure, a group of resonators for use in a rectangular waveguide filter comprises first through fourth resonators as defined above. The guide directions of the first through fourth resonators are aligned with each other and the first through fourth resonators are arranged along a guide direction of the first resonator, wherein the second and fourth resonators are rotated with respect to the first and third resonators by 180 degrees around rotation axes extending in the width direction. The second section of rectangular waveguide of the first resonator faces a part of the first section of rectangular waveguide of the second resonator, the second section of rectangular waveguide of the second resonator faces a part of the first section of rectangular waveguide of the first resonator, the second section of rectangular waveguide of the third resonator faces a part of the first section of rectangular waveguide of the fourth resonator, and the second section of rectangular waveguide of the fourth resonator faces a part of the first section of rectangular waveguide of the third resonator. The second section of rectangular waveguide of the second resonator is electromagnetically coupled to the first section of rectangular waveguide of the first resonator, the second section of rectangular waveguide of the first resonator is electromagnetically coupled to the first section of rectangular waveguide of the second resonator, the second section of rectangular waveguide of the fourth resonator is electromagnetically coupled to the first section of rectangular waveguide of the third resonator, the second section of rectangular waveguide of the third resonator is electromagnetically coupled to the first section of rectangular waveguide of the fourth resonator, and the first section of rectangular waveguide of the second resonator is further electromagnetically coupled to the first section of rectangular waveguide of the third resonator.

By this configuration, even greater length reduction compared to an equivalent four pole inductive filter may be achieved, while the same advantages with regard to manufacturability and performance as described above can still be achieved. As it turns out, a four pole filter employing the inventive group of resonators according to the above configuration is also shorter than an equivalent ridge resonator filter.

According to another aspect of the present disclosure, a rectangular waveguide filter comprises at least one resonator as defined above and/or at least one group of resonators as defined above.

### BRIEF DESCRIPTION OF THE SEVERAL VIEWS OF THE FIGURES

FIG. 1A is a perspective view of a rectangular waveguide filter according to the prior art;

FIG. 1B is a lateral view of the filter of FIG. 1A;

FIG. 1C is a horizontal cut through the filter of FIG. 1A;

FIG. 1D illustrates an electrical performance of the filter of FIG. 1A;

FIG. 2A is a perspective view of another rectangular waveguide filter according to the prior art;

FIG. 2B is a sagittal cut through the filter of FIG. 2A;

FIG. 2C is a horizontal cut through the filter of FIG. 2A;

FIG. 2D illustrates an electrical performance of the filter of FIG. 2A;

FIG. 3A is a perspective view of a rectangular waveguide filter according to a first embodiment of the present disclosure;

FIG. 3B is a lateral view of the filter of the first embodiment;

FIG. 3C is a sagittal cut through the filter of the first embodiment;

FIG. 3D is a horizontal cut through the filter of the first embodiment;

FIG. 3E illustrates an electrical performance of the filter of the first embodiment;

FIG. 4A is a perspective view of a rectangular waveguide filter according to a second embodiment of the present disclosure;

FIG. 4B is a lateral view of the filter of the second embodiment;

FIG. 4C is a sagittal cut through the filter of the second embodiment;

FIG. 4D is a horizontal cut through the filter of the second embodiment;

FIG. 4E illustrates an electrical performance of the filter of the second embodiment;

FIG. 5A is a perspective view of a rectangular waveguide filter according to a third embodiment of the present disclosure;

FIG. 5B is a lateral view of the filter of the third embodiment;

FIG. 5C is a sagittal cut through the filter of the third embodiment;

FIG. 5D is a horizontal cut through the filter of the third embodiment;

FIG. 5E illustrates an electrical performance of the filter of the third embodiment;

FIG. 6A is a perspective view of a rectangular waveguide filter according to a fourth embodiment of the present disclosure;

FIG. 6B is a lateral view of the filter of the fourth embodiment;

FIG. 6C is a sagittal cut through the filter of the fourth embodiment;

FIG. 6D is a first horizontal cut through the filter of the fourth embodiment;

FIG. 6E is a second horizontal cut through the filter of the fourth embodiment;

FIG. 6F illustrates an electrical performance of the filter of the fourth embodiment;

FIG. 7A is a perspective view of a rectangular waveguide filter according to a fifth embodiment of the present disclosure;

FIG. 7B is a lateral view of the filter of the fifth embodiment;

FIG. 7C is a sagittal cut through the filter of the fifth embodiment;

FIG. 7D is a first horizontal cut through the filter of the fifth embodiment;

FIG. 7E is a second horizontal cut through the filter of the fifth embodiment;

FIG. 7F illustrates an electrical performance of the filter of the fifth embodiment;

FIG. 8A illustrates the out-of-band performance of the filter of FIG. 1A;

FIG. 8B illustrates the out-of-band performance of the filter of FIG. 2A;

FIG. 8C illustrates the out-of-band performance of the filter of the third embodiment;

FIG. 8D illustrates the out-of-band performance of the filter of the fourth embodiment;

FIG. 9A illustrates the maximum bandwidth of a single pole inductive filter;

FIG. 9B illustrates the maximum bandwidth of a single pole ridge resonator filter; and

FIG. 9C illustrates the maximum bandwidth of the filter of the first or second embodiment.

### DETAILED DESCRIPTION

Preferred embodiments of the present disclosure will be described in the following with reference to the accompanying figures, wherein in the figures, identical objects are indicated by identical reference numbers. It is understood that the present disclosure shall not be limited to the described embodiments, and that the described features and aspects of the embodiments may be modified or combined to form further embodiments of the present disclosure.

The following detailed description refers to microwave filters. Therein, the term microwave filter is considered to indicate a filter suitable for filtering electromagnetic radiation having a frequency range for which use of a rectangular waveguide is appropriate.

Moreover, in the figures discussed in the following, the views of waveguide filters relate to an RF-path view, i.e., only the confining faces of the electromagnetic field inside the filters are shown. That is, the actual physical walls of the filters are not shown in the figures. However, it is understood that for each confining face a corresponding wall is present.

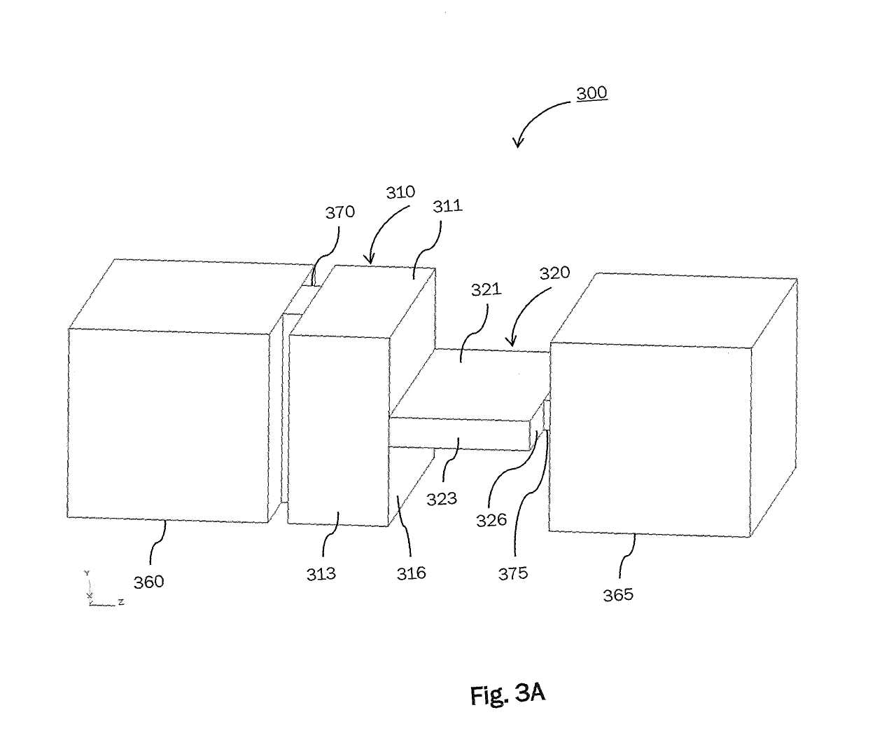

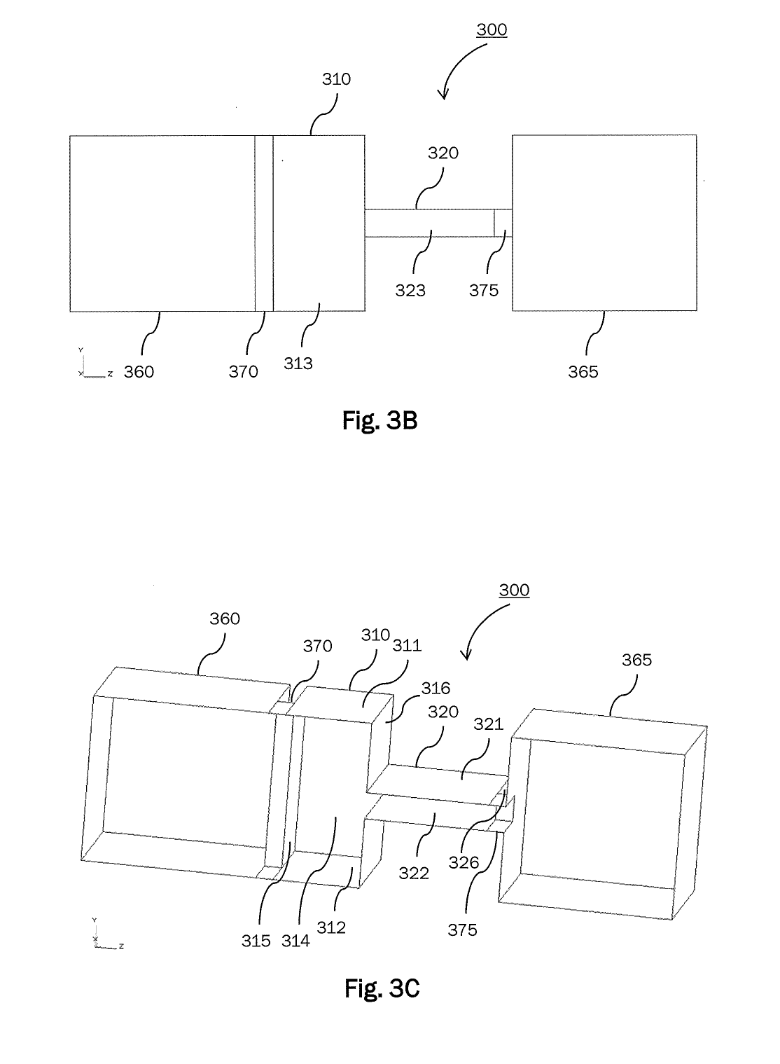

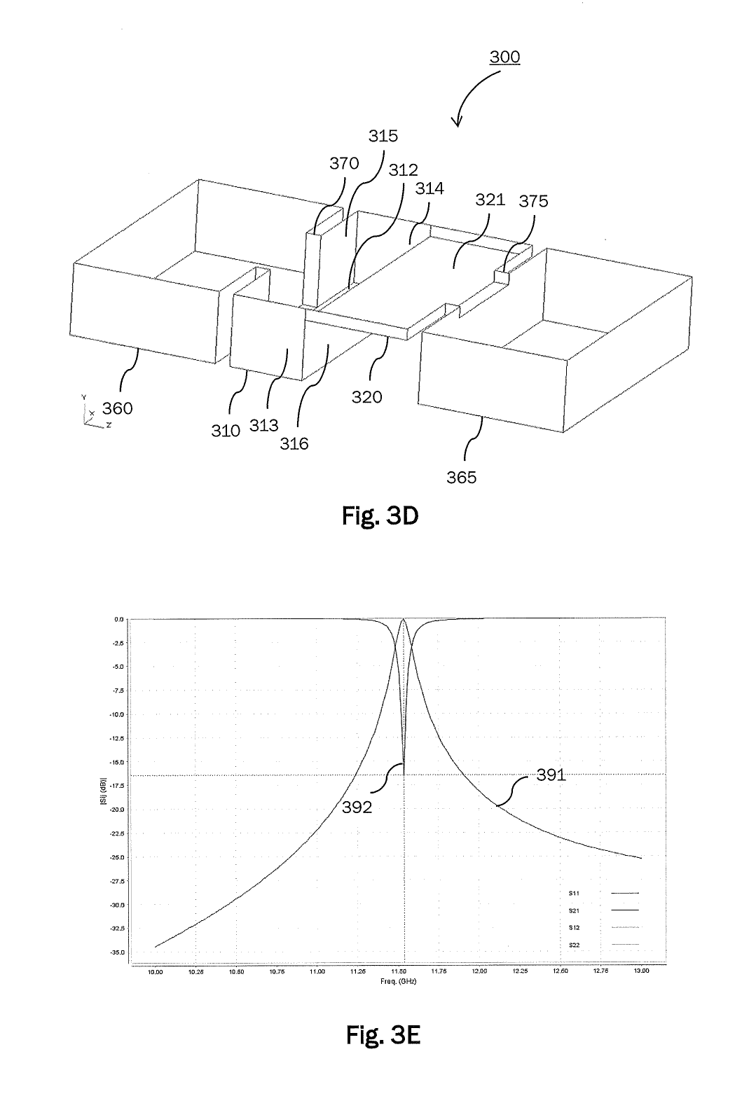

First, a rectangular waveguide filter 300 according to a first embodiment of the present disclosure will be described with reference to FIGS. 3A to 3E. FIG. 3A is a perspective view of the rectangular waveguide filter according to the first embodiment of the present disclosure, FIG. 3B is a lateral view of the rectangular waveguide filter, FIG. 3C is a sagittal cut (i.e., a cut along the y-z-plane) through the rectangular waveguide filter, FIG. 3D is a horizontal cut (i.e., a cut along the x-z-plane) through the rectangular waveguide filter, and FIG. 3E illustrates the electrical performance of the rectangular waveguide filter.

Referring to FIGS. 3A to 3D, directions with respect to a section of rectangular waveguide will be defined that shall be valid throughout the remainder of the description of the present disclosure. A guide direction (or longitudinal direction) of the section of rectangular waveguide extends in parallel to the H_{z}-component of the TE10 mode of the section of rectangular waveguide. A width direction of the section of rectangular waveguide is perpendicular to the guide direction and is defined by the two broad ones (i.e., longer ones) of the four sides of a cross-section of the section of rectangular waveguide perpendicular to the guide direction (i.e., the transverse cross-section, henceforth referred to simply as the cross-section). A height direction of the section of rectangular waveguide is perpendicular to the guide direction and to the width direction and is defined by the two narrow ones (i.e., shorter ones) of the four sides of the cross-section. In other words, the height direction extends in parallel to the E_{y}-component of the TE10 mode of the section of rectangular waveguide. Lastly, a center line of the section of rectangular waveguide is defined as a line extending in parallel to the guide direction and intersecting the cross-section of the section of rectangular waveguide in the center of the cross-section.

The rectangular waveguide filter illustrated in FIGS. 3A to 3D comprises a resonator 300 interposed between an input port 360 and an output port 365. The resonator 300 is coupled to the input port 360 through a first coupling section 370, and to the output port 365 through a second coupling section 375. Exemplarily, inductive coupling sections (inductive coupling windows or inductive coupling irises) are illustrated as the first and second coupling sections 370, 375. However, instead of inductive coupling sections, also alternative coupling sections that are readily apparent to persons of ordinary skill in the art can be used for coupling the resonator 300 to the input and output ports 360, 365, respectively, e.g., capacitive coupling sections (capacitive coupling windows or capacitive coupling irises) or hybrid coupling sections (hybrid coupling windows or hybrid coupling irises).

An inductive coupling section is understood as a coupling section having a rectangular cross section with a width of the cross section that is smaller than the width of the rectangular waveguide resonators that are coupled to each other by the inductive coupling section. The height of the cross section is equal to the height of the rectangular waveguide resonators. A capacitive coupling section is understood as a coupling section having a rectangular cross section with a height of the cross section that is smaller than the height of the rectangular waveguide resonators that are coupled to each other by the capacitive coupling section. The width of the cross section is equal to the width of the rectangular waveguide resonators. A hybrid coupling section is understood as a coupling section having a rectangular cross section with a width of the cross section that is smaller than the width of the rectangular waveguide resonators that are coupled to each other by the hybrid coupling section, and a height of the cross section that is smaller than the height of the rectangular waveguide resonators.

In the above and in the remainder of the present disclosure, it is generally understood that the term “coupling” refers to electromagnetic coupling. Electromagnetic coupling of two cavities is understood to indicate a situation in which electromagnetic fields present in the two cavities can influence each other, i.e., an electromagnetic field can spread over both cavities.

The resonator 300 consists of a series connection of a first section of rectangular waveguide 310 and a second section of rectangular waveguide 320 that are joined to each other to form the resonator 300. The first section of rectangular waveguide 310 is a conventional rectangular waveguide and has the function of an inductance. The second section of rectangular waveguide 320 has reduced height compared to the first section of rectangular waveguide 310 and has the function of a capacitance. This type of a resonator is referred to by the inventor as a lumped element rectangular waveguide (LERW) resonator.

The first section of rectangular waveguide 310 is bounded by four lateral walls 311, 312, 313, 314 which are all metallic walls. Lateral walls of the first section of rectangular waveguide 310 are those walls of the first section of rectangular waveguide 310 that extend in parallel to the guide direction of the first section of rectangular waveguide 310. Of the four lateral walls 311, 312, 313, 314, those two corresponding to broad sides (i.e., longer sides) of the cross-section of the first section of rectangular waveguide 310 are the top wall 311 and bottom wall 312 of the first section of rectangular waveguide 310 (broad walls of the first section of rectangular waveguide). Accordingly, the top and bottom walls 311, 312 of the first section of rectangular waveguide 310 each extend in a respective plane spanned by the guide direction and the width direction of the first section of rectangular waveguide 310 (i.e., spanned by the x-axis and the z-axis). On the other hand, of the four lateral walls 311, 312, 313, 314, those two corresponding to narrow sides (i.e., shorter sides) of the cross-section of the first section of rectangular waveguide 310 are the left and right walls 313, 314 of the first section of rectangular waveguide 310 (narrow walls of the first section of rectangular waveguide). The first section of rectangular waveguide 310 is further bounded by two end walls 315, 316 each extending in a respective plane perpendicular to the guide direction of the first section of rectangular waveguide 310.

Likewise, the second section of rectangular waveguide 320 is bounded by four lateral walls 321, 322, 323, 324 which are all metallic walls. Lateral walls of the second section of rectangular waveguide 320 are those walls of the second section of rectangular waveguide 320 that extend in parallel to the guide direction of the second section of rectangular waveguide 320. Of the four lateral walls 321, 322, 323, 324, those two corresponding to broad sides (i.e., longer sides) of the cross section of the second section of rectangular waveguide 320 are the top wall 321 and bottom wall 322 of the second section of rectangular waveguide 320 (broad walls of the second section of rectangular waveguide). Accordingly, the top and bottom walls 321, 322 of the second section of rectangular waveguide 320 each extend in a respective plane spanned by the guide direction and the width direction of the second section of rectangular waveguide 320 (i.e., spanned by the x-axis and the z-axis). On the other hand, of the four lateral walls 321, 322, 323, 324, those two corresponding to narrow sides (i.e., shorter sides) of the cross section of the second section of rectangular waveguide 320 are the left and right walls 323, 324 of the second section of rectangular waveguide 320 (narrow walls of the second section of rectangular waveguide). The second section of rectangular waveguide 320 is further bounded by an end wall 326 extending in a plane perpendicular to the guide direction of the second section of rectangular waveguide 320, whereas at the opposite end of the second section of rectangular waveguide 320 no end wall is present due to the series connection of the first and second sections of rectangular waveguide 310, 320.

The first section of rectangular waveguide 310 and the second section of rectangular waveguide 320 are arranged along a guide direction of the resonator 300 and are joined to each other to form the resonator 300. The walls of the second section of rectangular waveguide 320 that extend in the guide direction (i.e., the lateral walls) are in a parallel relationship with respective walls (i.e., lateral walls) of the first section of rectangular waveguide 310. In other words, the guide direction of the first section of rectangular waveguide 310 and the guide direction of the second section of rectangular waveguide 320 extend in parallel, and also their width and height directions, respectively, extend in parallel.

Further, a width of the first section of rectangular waveguide 310, i.e., a length of the broader (i.e., longer) sides of the cross-section of the first section of rectangular waveguide 310, is equal to a width of the second section of rectangular waveguide 320, i.e., a length of the broader (i.e., longer) sides of the cross-section of the second section of rectangular waveguide 320. That is, the resonator 300 has uniform width in a sense that there is not any portion of the resonator 300 that has a reduced width compared to the rest of the resonator 300. In other words, the narrow walls 313, 314 of the first section of rectangular waveguide 310 corresponding to narrower (i.e., shorter) sides of the cross-section of the first section of rectangular waveguide 310, i.e., left and right walls 313, 314 are aligned with respective left and right walls 323, 324 of the second section of rectangular waveguide 320. Since the first and second sections of rectangular waveguide 310, 320 have identical width, for simplicity it can be referred to the (uniform) width of the resonator 300 instead of to the widths of the first and second sections of rectangular waveguide 310, 320.

It is further to be noted that the first and second sections of rectangular waveguide 310, 320 are joined together without any interposed coupling sections or coupling irises, as can be seen in FIG. 3D. FIG. 3D is a horizontal cut through the rectangular waveguide filter of the first embodiment, wherein the cutting plane has been chosen so as to extend through the second section of rectangular waveguide 320 of the resonator 300.

On the other hand, a height of the second section of rectangular waveguide 320, i.e., a length of the narrower (i.e., shorter) sides of the cross-section of the second section of rectangular waveguide 320 is smaller than a height of the first section of the rectangular waveguide 310, i.e., a length of the narrower (i.e., shorter) sides of the cross-section of the first section of rectangular waveguide 310.

Let the width of the first section of rectangular waveguide 310 in its width direction be denoted by a1, and the height of the first section of rectangular waveguide 310 in its height direction be denoted by b1. Likewise, let the width of the second section of rectangular waveguide 320 in its width direction be denoted by a2, and the height of the second section of rectangular waveguide 320 in its height direction be denoted by b2. As indicated above, in the first embodiment of the present disclosure, the width a1 of the first section of rectangular waveguide 310 is substantially equal to the width a2 of the second section of rectangular waveguide 320, i.e., a1=a2=a, where a is the (uniform) width of the resonator 300. The height b2 of the second section of rectangular waveguide 320 is smaller than the height b1 of the first section of rectangular waveguide 310, i.e., b2<b1. Moreover, by definition, we have a1>b1 and a2>b2.

Further, with this configuration, let the electric length of the first section of rectangular waveguide 320 in its guide direction be denoted by l1 and the electric length of the second section of rectangular waveguide 320 in its guide direction be denoted by l2. Typically, resonators of rectangular waveguide have an electric length that corresponds to an integer multiple of half the wavelength of the desired base mode of the resonator. In the first embodiment, the electric length l1 of the first section of rectangular waveguide 310 is substantially equal to or shorter than the electric length l2 of the second section of rectangular waveguide 320, i.e., l1≦l2.

As can be seen from FIGS. 3A to 3C, a horizontal center plane of the first section of rectangular waveguide 310 is aligned with a horizontal center plane of the second section of rectangular waveguide 320, wherein the horizontal center plane of a section of rectangular waveguide is the horizontal plane (a plane extending along the guide direction and the width direction of the respective section of rectangular waveguide, or along the z-axis and the x-axis) that contains the center axis of the respective section of rectangular waveguide. In other words, the center axis of first section of rectangular waveguide 310 is aligned with the center axis of the second section of rectangular waveguide 320. Since the center axis of the first section of rectangular waveguide 310 is aligned with the center axis of the second section of rectangular waveguide 320, either of these center axes can be taken to define a center axis of the resonator 300.

As follows from the above, the resonator 300 of the first embodiment is symmetric with respect to a center horizontal plane which imaginarily cuts the resonator 300 in equal upper and lower halves. For this reason, the resonator 300 of the first embodiment is referred to by the inventor as a symmetric LERW resonator or SLERW resonator.

FIG. 3E illustrates the electrical performance of the rectangular waveguide filter of FIGS. 3A to 3D. The abscissa indicates the frequency in units of GHz and the ordinate indicates the S-parameter of the rectangular waveguide filter in units of dB. Graph 391 indicates the S21-component of the S-parameter, and graph 392 indicates the S11-component of the S-parameter. For reasons of symmetry, S11=S22 and S21=S12 hold for the rectangular waveguide filter. As can be seen from FIG. 3E, S11 has a single pole in the passband indicated by S21 (in the figure at about 11.54 GHz).

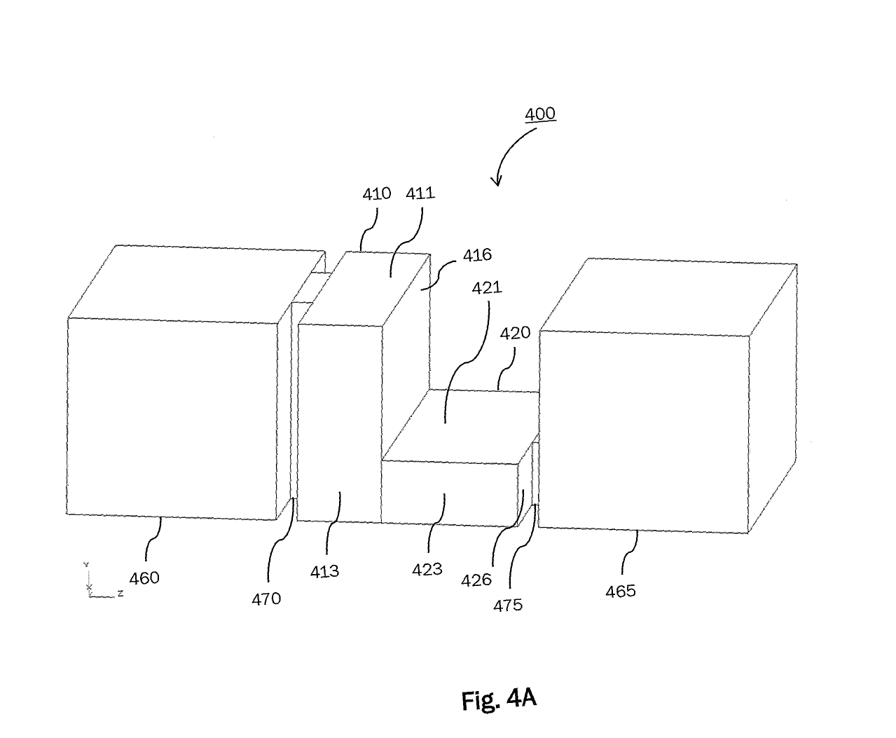

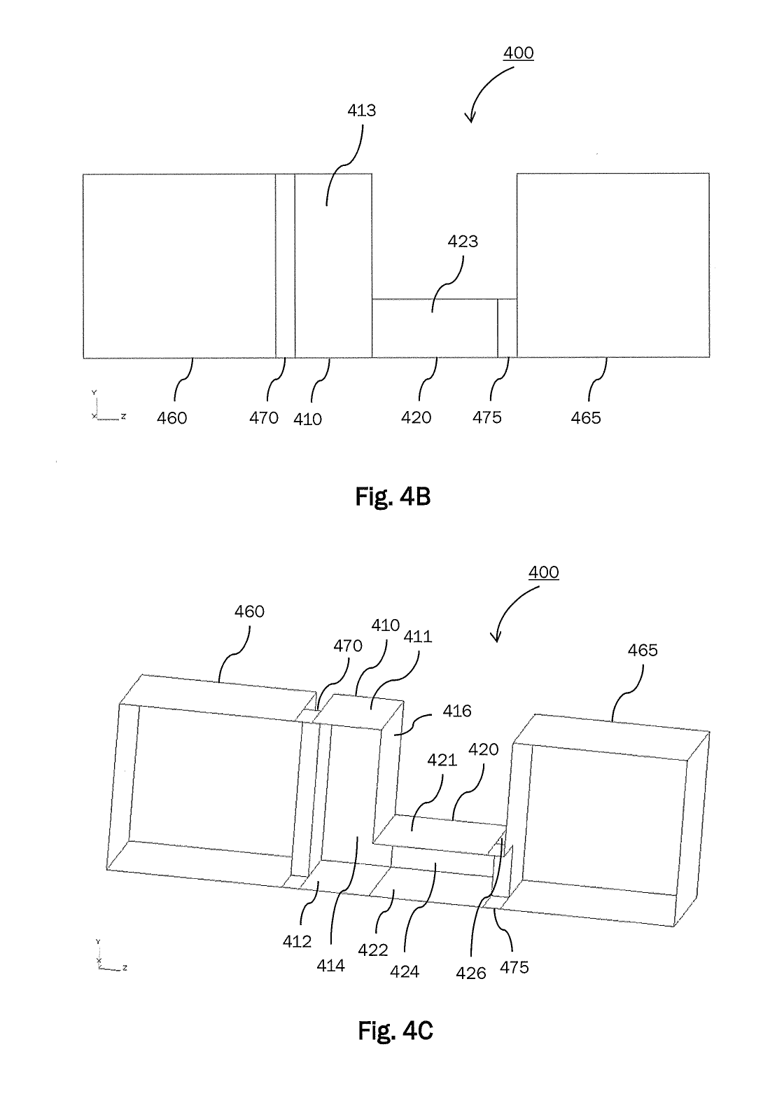

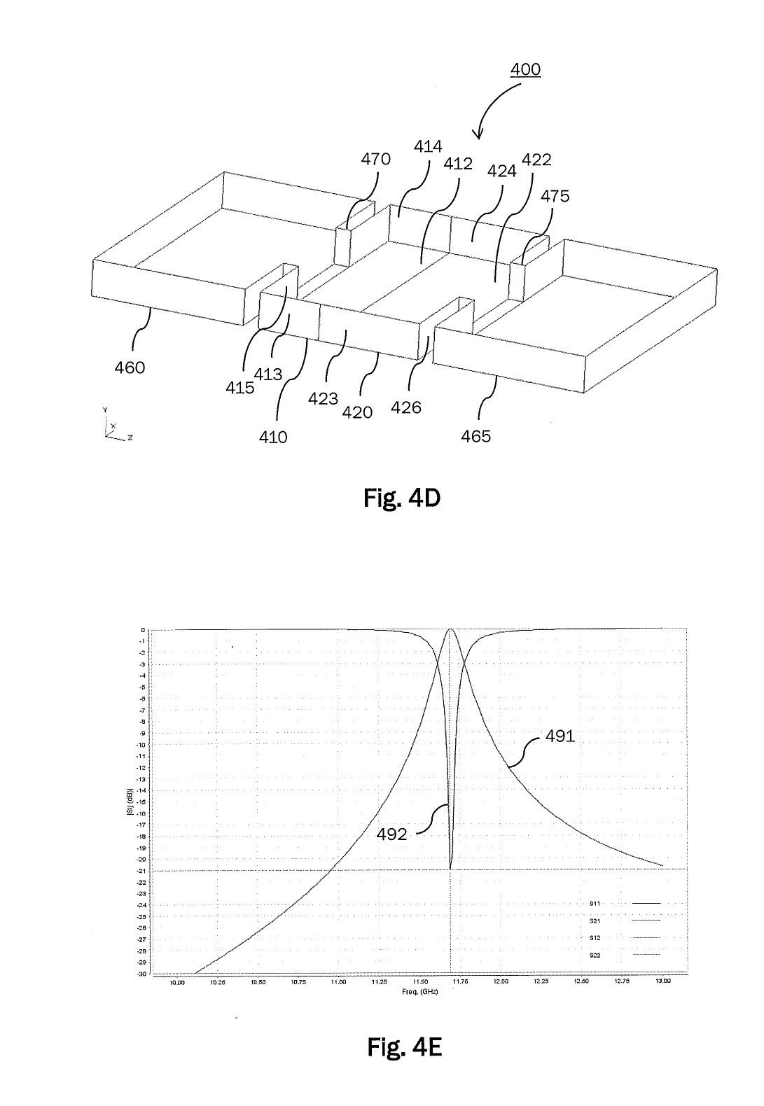

Next, a rectangular waveguide filter according to a second embodiment of the present disclosure will be described with reference to FIGS. 4A to 4E. FIG. 4A is a perspective view of the rectangular waveguide filter according to the second embodiment of the present disclosure, FIG. 4B is a lateral view of the rectangular waveguide filter, FIG. 4C is a sagittal cut (i.e., a cut along the y-z-plane) through the rectangular waveguide filter, FIG. 4D is a horizontal cut (i.e., a cut along the x-z-plane) through the rectangular waveguide filter, and FIG. 4E illustrates the electrical performance of the rectangular waveguide filter.

The rectangular waveguide filter illustrated in FIGS. 4A to 4D comprises a resonator 400 interposed between an input port 460 and an output port 465. The resonator 400 is coupled to the input port 460 through a first coupling section 470, and to the output port 465 through a second coupling section 475. Exemplarily, inductive coupling sections (inductive coupling windows or inductive coupling irises) are illustrated as the first and second coupling sections 470, 475. However, instead of inductive coupling sections, also alternative coupling sections that are readily apparent to persons of ordinary skill in the art can be used for coupling the resonator 400 to the input and output ports 460, 465, respectively, e.g., capacitive coupling sections (capacitive coupling windows or capacitive coupling irises) or hybrid coupling sections (hybrid coupling windows or hybrid coupling irises).

As was the case in the first embodiment, the resonator 400 consists of a series connection of a first section of rectangular waveguide 410 and a second section of rectangular waveguide 420 that are joined to each other to form the resonator 400. The first section of rectangular waveguide 410 is a conventional rectangular waveguide and has the function of an inductance. The second section of rectangular waveguide 420 has reduced height compared to the first section of rectangular waveguide 410 and has the function of a capacitance. As will become apparent from the below description, the resonator 400 according to the second embodiment is different from the resonator 300 according to the first embodiment in that the center axes of the first and second sections of rectangular waveguide 410, 420 are offset in the height direction.

The first section of rectangular waveguide 410 is bounded by four lateral walls 411, 412, 413, 414 which are all metallic walls. Lateral walls of the first section of rectangular waveguide 410 are those walls of the first section of rectangular waveguide 410 that extend in parallel to the guide direction of the first section of rectangular waveguide 410. Of the four lateral walls 411, 412, 413, 414, those two corresponding to broad sides (i.e., longer sides) of the cross-section of the first section of rectangular waveguide 410 are the top wall 411 and bottom wall 412 of the first section of rectangular waveguide 410 (broad walls of the first section of rectangular waveguide). Accordingly, the top and bottom walls 411, 412 of the first section of rectangular waveguide 310 each extend in a respective plane spanned by the guide direction and the width direction of the first section of rectangular waveguide 410 (i.e., spanned by the x-axis and the z-axis). On the other hand, of the four lateral walls 411, 412, 413, 414, those two corresponding to narrow sides (i.e., shorter sides) of the cross-section of the first section of rectangular waveguide 410 are the left and right walls 413, 414 of the first section of rectangular waveguide 410 (narrow walls of the first section of rectangular waveguide). The first section of rectangular waveguide 410 is further bounded by two end walls 415, 416 each extending in a respective plane perpendicular to the guide direction of the first section of rectangular waveguide 410.

Likewise, the second section of rectangular waveguide 420 is bounded by four lateral walls 421, 422, 423, 424 which are all metallic walls. Lateral walls of the second section of rectangular waveguide 420 are those walls of the second section of rectangular waveguide 420 that extend in parallel to the guide direction of the second section of rectangular waveguide 420. Of the four lateral walls 421, 422, 423, 424, those two corresponding to broad sides (i.e., longer sides) of the cross section of the second section of rectangular waveguide 420 are the top wall 421 and bottom wall 422 of the second section of rectangular waveguide 420 (broad walls of the second section of rectangular waveguide). Accordingly, the top and bottom walls 421, 422 of the second section of rectangular waveguide 420 each extend in a respective plane spanned by the guide direction and the width direction of the second section of rectangular waveguide 420 (i.e., spanned by the x-axis and the z-axis). On the other hand, of the four lateral walls 421, 422, 423, 424, those two corresponding to narrow sides (i.e., shorter sides) of the cross section of the second section of rectangular waveguide 420 are the left and right walls 423, 424 of the second section of rectangular waveguide 420 (narrow walls of the second section of rectangular waveguide).

The second section of rectangular waveguide 420 is further bounded by an end wall 426 extending in a plane perpendicular to the guide direction of the second section of rectangular waveguide 420, whereas at the opposite end of the second section of rectangular waveguide 420 no end wall is present due to the series connection of the first and second sections of rectangular waveguide 410, 420.

The first section of rectangular waveguide 410 and the second section of rectangular waveguide 420 are arranged along a guide direction of the resonator 400 and are joined to each other to form the resonator 400. The walls of the second section of rectangular waveguide 420 that extend in the guide direction (i.e., the lateral walls) are in a parallel relationship with respective walls (i.e., lateral walls) of the first section of rectangular waveguide 410. In other words, the guide direction of the first section of rectangular waveguide 410 and the guide direction of the second section of rectangular waveguide 420 extend in parallel, and also their width and height directions, respectively, extend in parallel.

Further, a width of the first section of rectangular waveguide 410, i.e., a length of the broader (i.e., longer) sides of the cross-section of the first section of rectangular waveguide 410, is equal to a width of the second section of rectangular waveguide 420, i.e., a length of the broader (i.e., longer) sides of the cross-section of the second section of rectangular waveguide 420. That is, the resonator 400 has uniform width in a sense that there is not any portion of the resonator 400 that has a reduced width compared to the rest of the resonator 400. In other words, the narrow walls 413, 414 of the first section of rectangular waveguide 410 corresponding to narrower (i.e., shorter) sides of the cross-section of the first section of rectangular waveguide 410, i.e., left and right walls 413, 414 are aligned with respective left and right walls 423, 424 of the second section of rectangular waveguide 420. Since the first and second sections of rectangular waveguide 410, 420 have identical width, for simplicity it can be referred to the (uniform) width of the resonator 400 instead of to the widths of the first and second sections of rectangular waveguide 410, 420.

Further, it is to be noted that the first and second sections of rectangular waveguide 410, 420 are joined together without any interposed coupling sections or coupling irises, as can be seen in FIG. 4D. FIG. 4D is a horizontal cut through the rectangular waveguide filter of the second embodiment, wherein the cutting plane has been chosen so as to extend through the second section of rectangular waveguide 420 of the resonator 400.

On the other hand, a height of the second section of rectangular waveguide 420, i.e., a length of the narrower (i.e., shorter) sides of the cross-section of the second section of rectangular waveguide 420 is smaller than a height of the first section of the rectangular waveguide 410, i.e., a length of the narrower (i.e., shorter) sides of the cross-section of the first section of rectangular waveguide 410.

Let the width of the first section of rectangular waveguide 410 in its width direction be denoted by a1, and the height of the first section of rectangular waveguide 410 in its height direction be denoted by b1. Likewise, let the width of the second section of rectangular waveguide 420 in its width direction be denoted by a2, and the height of the second section of rectangular waveguide 420 in its height direction be denoted by b2. As indicated above, in the second embodiment of the present disclosure, the width a1 of the first section of rectangular waveguide 410 is substantially equal to the width a2 of the second section of rectangular waveguide 420, i.e., a1=a2=a, where a is the (uniform) width of the resonator 400. In the second embodiment, the height b2 of the second section of rectangular waveguide 420 is at most half the height b1 of the first section of rectangular waveguide 410. By definition, we have a1>b1 and a2>b2.

Further, let the electric length of the first section of rectangular waveguide 410 in its guide direction be denoted by l1 and the electric length of the second section of rectangular waveguide 420 in its guide direction be denoted by l2. Typically, resonators of rectangular waveguide have an electric length that corresponds to an integer multiple of half the wavelength of the desired base mode of the resonator. Also in the second embodiment, the electric length l1 of the first section of rectangular waveguide 410 is substantially equal to or shorter than the electric length l2 of the second section of rectangular waveguide 420, i.e., l1≦l2.

As can be seen from FIGS. 4A to 4C, a horizontal center plane of the second section of rectangular waveguide 420 is displaced (shifted, or offset) in the height direction with respect to a horizontal center plane of the first section of rectangular waveguide 410. In other words, the center axis of the second section of rectangular waveguide 420 is not aligned with the center axis of the first section of rectangular waveguide 410, but is displaced (shifted, or offset) in the height direction with respect to the center axis of the first section of rectangular waveguide 410. Since the center axis of the first section of rectangular waveguide 410 is not aligned with the center axis of the second section of rectangular waveguide 420, the center axis of the first section of rectangular waveguide 410 is taken to define a center axis of the resonator 400.

As follows from the above, the resonator 400 of the second embodiment is asymmetric with respect to the center horizontal plane of the first section of rectangular waveguide 410. For this reason, the resonator 400 of the second embodiment is referred to by the inventor as an asymmetric LERW resonator or ALERW resonator.

The center axis of the second section of rectangular waveguide 420 is shifted in the height direction relative to the center axis of the first section of rectangular waveguide 410 by at least half the height of the second section of rectangular waveguide 420. Thereby, if the end face 416 of first section of rectangular waveguide 410 that faces towards the second section of rectangular waveguide 420 is imaginarily divided into an upper half and a lower half, either the upper half or the lower half, depending on the direction of the shift of center axes of the first and second sections of rectangular waveguide 410, 420, is not covered by the second section of rectangular waveguide 420. In other words, if the resonator 400 is imaginarily divided into an upper half and a lower half, the second section of rectangular waveguide 420 is located either in only the upper half or in only the lower half, depending on the direction of the shift of center axes of the first and second sections of rectangular waveguide 410, 420.

In a preferred embodiment, the shift of center axes of the first and second sections of rectangular waveguide 410, 420 is chosen so that one of lateral walls of the second section of rectangular waveguide 420 that correspond to a broader one of dimensions of a transverse cross-section of the second section of rectangular waveguide 420 (i.e., one of broad walls of the second section of rectangular waveguide) is aligned with a respective one of lateral walls of the first section of rectangular waveguide 410 that correspond to the broader one of dimensions of the transverse cross-section of the first section of rectangular waveguide 410 (i.e., one of broad walls of the first section of rectangular waveguide). That is, the top wall 421 (bottom wall 422) of the second section of rectangular waveguide 420 is aligned with the top wall 411 (bottom wall 412) of the first section of rectangular waveguide 410.

This case is illustrated in FIGS. 4A to 4D, in which the bottom wall 422 of the second section of rectangular waveguide 420 is aligned with the bottom wall 412 of the first section of rectangular waveguide 410. As indicated above, it is understood that of course also the opposite case in which the top wall 421 of the second section of rectangular waveguide 420 is aligned with the top wall 411 of the first section of rectangular waveguide 410 is comprised by the scope of the present disclosure.

FIG. 4E illustrates the electrical performance of the rectangular waveguide filter of FIGS. 4A to 4D. The abscissa indicates the frequency in units of GHz and the ordinate indicates the S-parameter of the rectangular waveguide filter in units of dB. Graph 491 indicates the S21-component of the S-parameter, and graph 492 indicates the S11-component of the S-parameter. For reasons of symmetry, S11=S22 and S21=S12 hold for the rectangular waveguide filter. As can be seen from FIG. 4E, S11 has a single pole in the passband indicated by S21 (in the figure at about 11.69 GHz).

The basic resonators 300, 400 of the first and second embodiments of the present disclosure described above can be used to implement a number of different passband filters according to the further embodiments of the present disclosure described below. Of these, the third embodiment relates to a four pole filter comprising the resonator 300 of the first embodiment as the basic building block, the fourth embodiment relates to a four pole filter comprising the resonator 400 of the second embodiment as the basic building block, and the fifth embodiment relates to a second order filter (two pole filter) comprising the resonator 400 of the second embodiment as the basic building block. It is understood that further combinations of the basic resonators according to the first and second embodiments are readily apparent to persons of ordinary skill in the art, and that the scope of the present disclosure is not limited to the particular choice of filter implementations presented below.

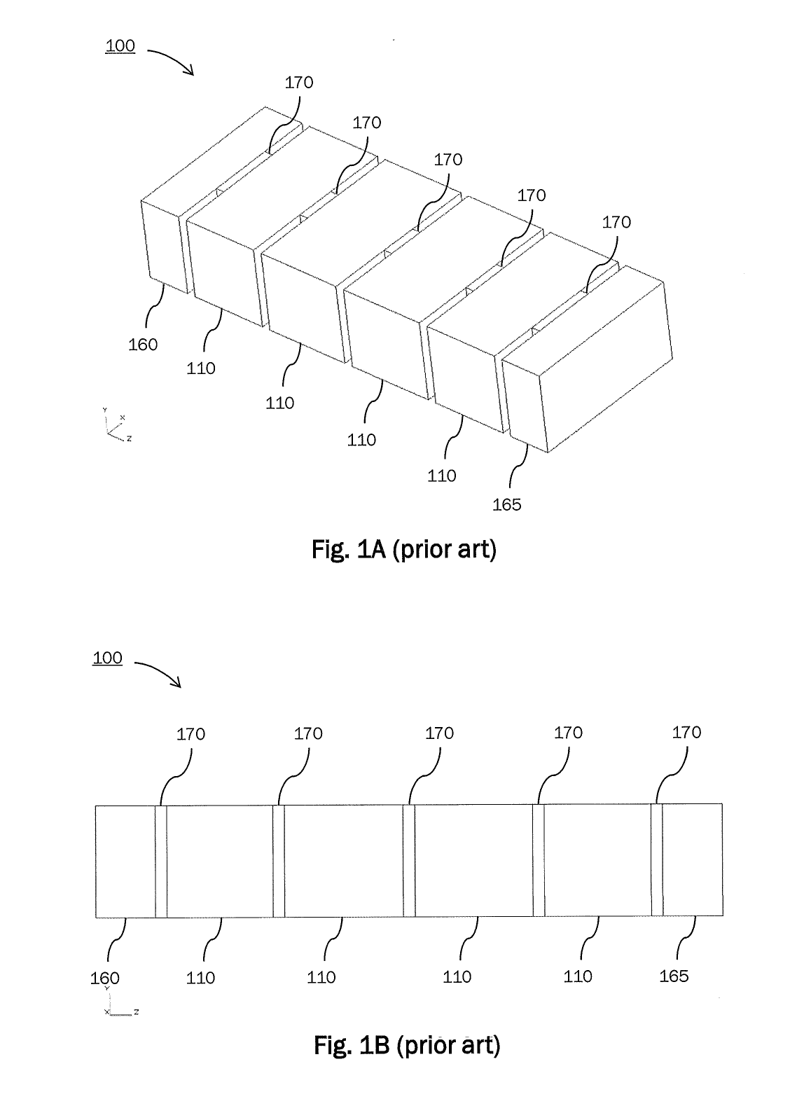

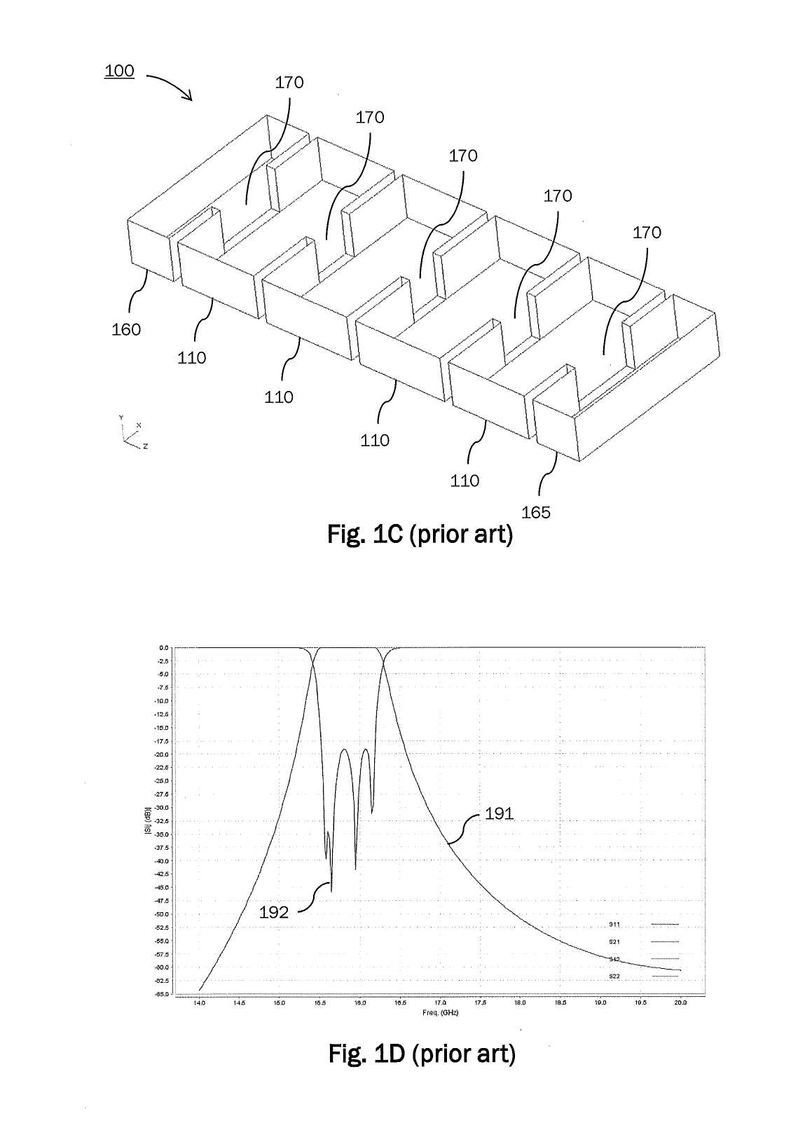

A common approach for manufacturing inductive filters of the type shown in FIGS. 1A to 1C is to cut the hardware longitudinally in two identical parts. Each individual part is machined separately and the filter is realized by assembly the two parts. Several different technologies can be used for the actual mechanical realization depending on the required accuracy. The same philosophy for manufacture is fully applicable to the filters according to the embodiments of the present disclosure. Therefore, the filters according to the embodiments of the disclosure can be manufactured in a particularly simple and inexpensive manner. If necessary, tuning screws could also be included in the center of the resonators of the filters according to the embodiments of the disclosure without major difficulties.

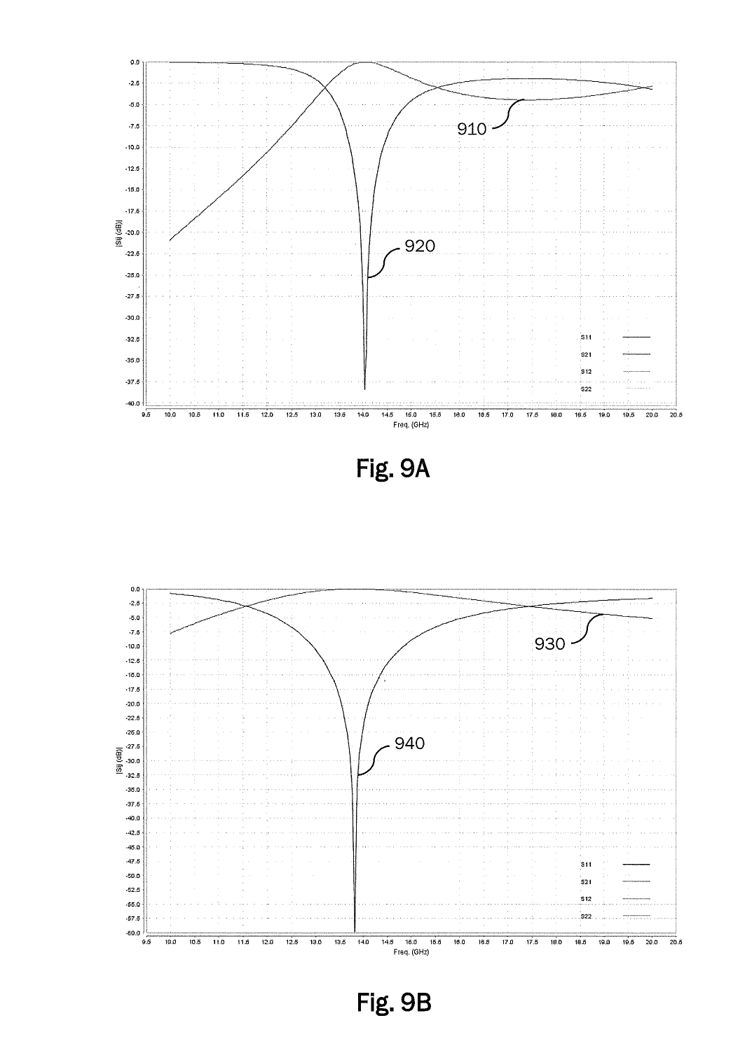

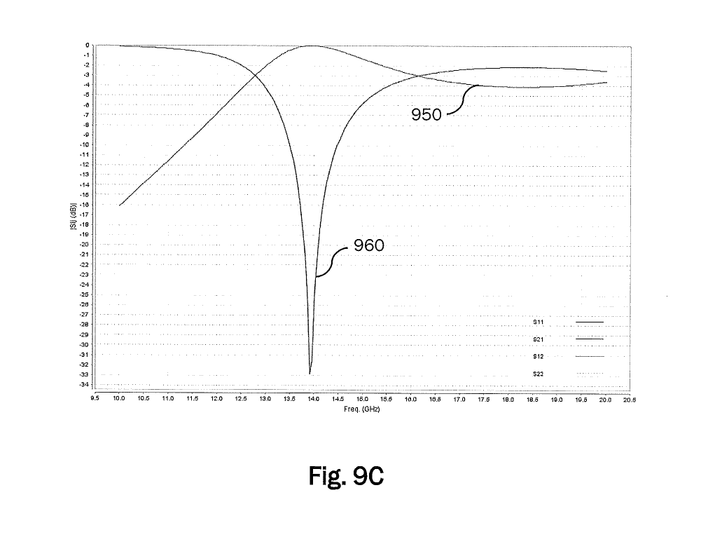

A further feature that is of importance in microwave filter design is the maximum bandwidth that can be achieved. In FIGS. 9A to 9C the performances with regard to maximum bandwidth of a single pole inductive filter (cf. FIG. 9A), a single pole ridge resonator filter (cf. FIG. 9B), and a single pole LERW filter (cf. FIG. 9C) according to either the first or second embodiment are compared to each other. It is found that for a maximum bandwidth of a reference inductive filter of about 2.3 GHz, an equivalent ridge resonator filter has a maximum bandwidth of about 5.8 GHz, while an equivalent LERW filter has a maximum bandwidth of about 3.4 GHz. Thus, it is found that the LERW filters according to the present disclosure can achieve a maximum bandwidth that is between those of equivalent inductive filters and equivalent ridge resonator filters.

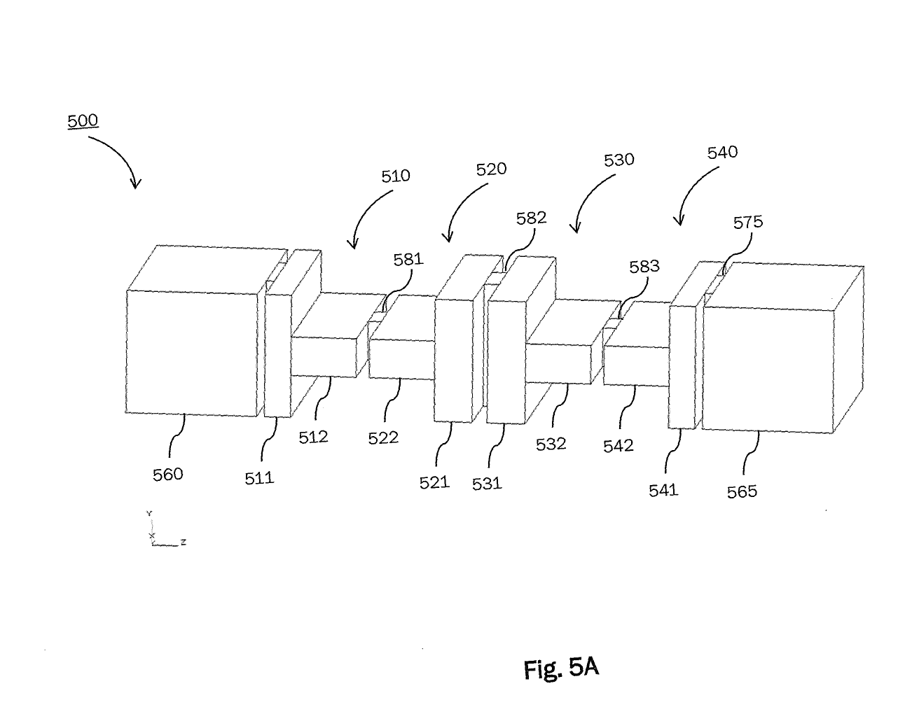

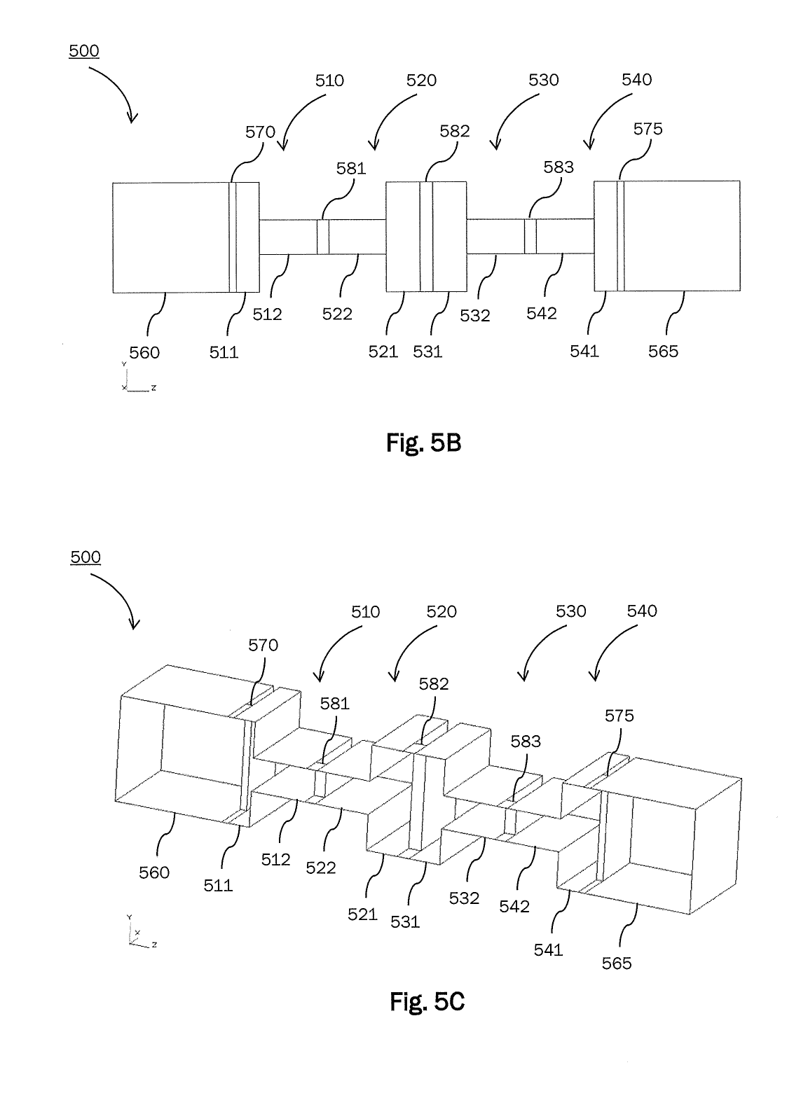

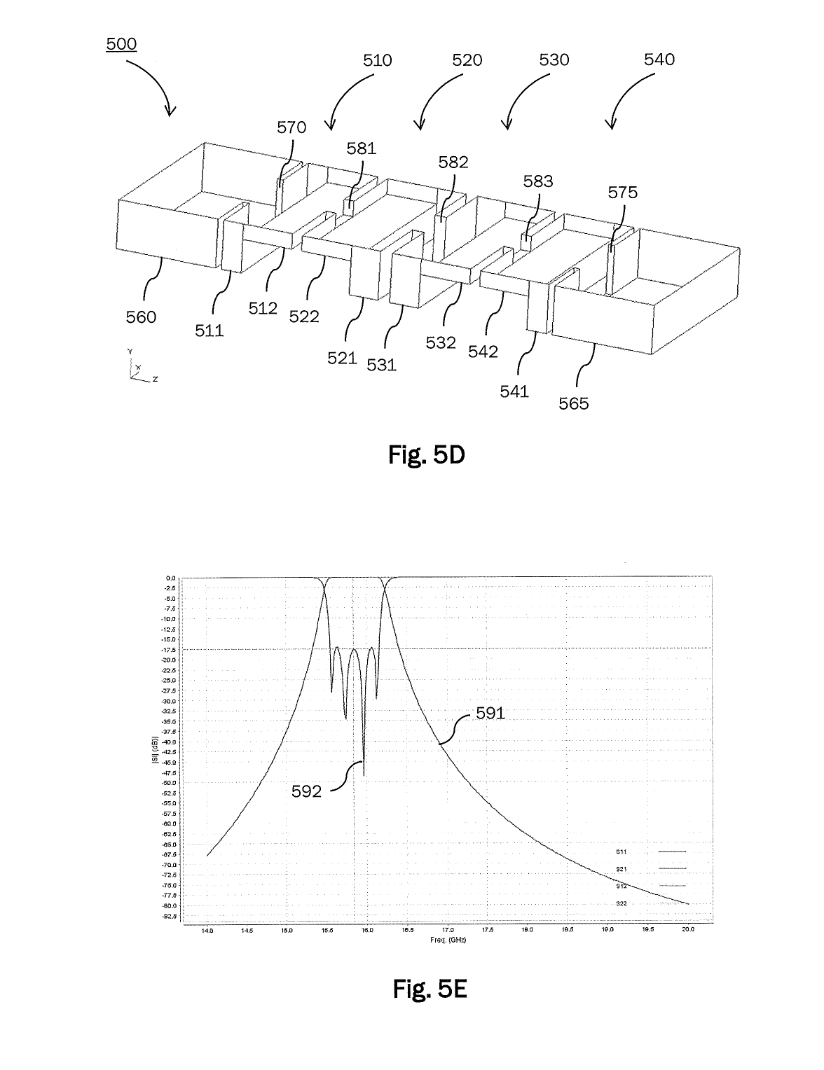

A rectangular waveguide filter 500 according to a third embodiment of the present disclosure will now be described with reference to FIGS. 5A to 5E. FIG. 5A is a perspective view of the rectangular waveguide filter 500 according to the third embodiment of the present disclosure, FIG. 5B is a lateral view of the rectangular waveguide filter 500, FIG. 5C is a sagittal cut (i.e., a cut along the y-z-plane) through the rectangular waveguide filter 500, FIG. 5D is a horizontal cut (i.e., a cut along the x-z-plane) through the rectangular waveguide filter 500, and FIG. 5E illustrates the electrical performance of the rectangular waveguide filter 500.

The rectangular waveguide filter 500 illustrated in FIGS. 5A to 5D comprises a series of first to fourth resonators 510, 520, 530, 540, each of which is a resonator according to the first embodiment (cf. FIGS. 3A to 3D). Therefore, each of the first to fourth resonators 510, 520, 530, 540 comprises a first section of rectangular waveguide 511, 521, 531, 541 and a second section of rectangular waveguide 512, 522, 532, 542.

In the rectangular waveguide filter 500 illustrated in FIGS. 5A to 5D, the widths of the first to fourth resonators 510, 520, 530, 540 are identical. Moreover, the first sections of rectangular waveguide 511, 521, 531, 541 have identical height, and the second sections of rectangular waveguide 512, 522, 532, 542 have identical height. However, the electric lengths of the first sections of rectangular waveguide 511, 521, 531, 541 may be different from each other, and the electric lengths of the second sections of rectangular waveguide 512, 522, 532, 543 may be different from each other. In other words, each of the electric lengths of the first and second sections of the first to fourth resonators 510, 520, 530, 540, respectively, is a design parameter that may be chosen independently from the other design parameters in accordance with filter requirements.

In a preferred embodiment, the electric lengths of the first sections of rectangular waveguide 511, 541 of the first and fourth resonators 510, 540 are identical, and the electric lengths of the first sections of rectangular waveguide 521, 531 of the second and third resonators 520, 530 are identical. Moreover, in the preferred embodiment, the electric lengths of the second sections of rectangular waveguide 512, 542 of the first and fourth resonators 510, 540 are identical, and the electric lengths of the second sections of rectangular waveguide 521, 531 of the second and third resonators 520, 530 are identical. In a further preferred embodiment, the first to fourth resonators 510, 520, 530, 540 are identical resonators, i.e., their widths, heights, and electric lengths are identical.

The series of resonators 510, 520, 530, 540 is interposed between an input port 560 and an output port 565. The first resonator 510 of the series of resonators is coupled to the input port 560 through a first coupling section 570, and the fourth resonator 540 of the series of resonators is coupled to the output port 565 through a second coupling section 575. Exemplarily, inductive coupling sections (inductive coupling windows or inductive coupling irises) are illustrated as the first and second coupling sections 570, 575. However, instead of inductive coupling sections, also alternative coupling sections that are readily apparent to persons of ordinary skill in the art can be used for coupling the first and fourth resonators 510, 540 to the input and output ports 560, 565, respectively, e.g., capacitive coupling sections (capacitive coupling windows or capacitive coupling irises) or hybrid coupling sections (hybrid coupling windows or hybrid coupling irises).

The first to fourth resonators 510, 520, 530, 540 are arranged along the guide direction of the filter 500, wherein the center axes of the first to fourth resonators 510, 520, 530, 540 extend in parallel to each other and are aligned with each other. Moreover, the first to fourth resonators 510, 520, 530, 540 are oriented so that their width directions and height directions, respectively, extend in parallel to each other. In other words, corresponding broad walls of the four first sections of rectangular waveguide 511, 521, 531, 541 are aligned with each other, corresponding broad walls of the four second sections of rectangular waveguide 512, 522, 532, 542 are aligned with each other, corresponding narrow walls of the four first sections of rectangular waveguide 511, 521, 531, 541 are aligned with each other, and corresponding narrow walls of the four second sections of rectangular waveguide 512, 522, 532, 542 are aligned with each other. As indicated above, the widths and heights of the first to fourth resonators 510, 520, 530, 540 are identical.

The first section of rectangular waveguide 511 of the first resonator 510 is coupled to the input port 560 through the first coupling section 570. The second section of rectangular waveguide 512 of the first resonator 510 is coupled to the second section of rectangular waveguide 522 of the second resonator 520 through a first intermediate coupling section 581. The first section of rectangular waveguide 521 of the second resonator 520 is coupled to the first section of rectangular waveguide 531 of the third resonator 530 through a second intermediate coupling section 582. The second section of rectangular waveguide 532 of the third resonator 530 is coupled to the second section of rectangular waveguide 542 of the fourth resonator 540 through a third intermediate coupling section 583. The first section of rectangular waveguide 541 of the fourth resonator 540 is coupled to the output port 565 through the second coupling section 575.

Exemplarily, inductive coupling sections (inductive coupling windows or inductive coupling irises) are illustrated as the first to third intermediate coupling sections 581, 582, 583. However, instead of inductive coupling sections, also alternative coupling sections that are readily apparent to persons of ordinary skill in the art can be used for coupling the first to fourth resonators 510, 520, 530, 540 to each other, respectively, e.g., capacitive coupling sections (capacitive coupling windows or capacitive coupling irises) or hybrid coupling sections (hybrid coupling windows or hybrid coupling irises).

As follows from the above description of the rectangular waveguide filter 500 of the third embodiment, the guide directions of the first through fourth resonators 510, 520, 530, 540 are aligned with each other and the first through fourth resonators 510, 520, 530, 540 are arranged along the guide direction of the first resonator 510, so that the second section of rectangular waveguide 512 of the first resonator 510 faces the second section of rectangular waveguide 522 of the second resonator 520, the first section of rectangular waveguide 521 of the second resonator 520 faces the first section of rectangular waveguide 531 of the third resonator 530, and the second section of rectangular waveguide 532 of the third resonator 530 faces the second section of rectangular waveguide 542 of the fourth resonator 540. Further, the second section of rectangular waveguide 512 of the first resonator 510 is electromagnetically coupled to the second section of rectangular waveguide 522 of the second resonator 520, the first section of rectangular waveguide 521 of the second resonator 520 is electromagnetically coupled to the first section of rectangular waveguide 531 of the third resonator 530, and the second section of rectangular waveguide 532 of the third resonator 530 is electromagnetically coupled to the second section of rectangular waveguide 542 of the fourth resonator 540.

Equivalently, it can be said that the second and fourth resonators 520, 540 are rotated with respect to the first and third resonators 510, 530 by 180 degrees about a rotation axis extending along the height direction or, alternatively, by 180 degrees about a rotation axis extending along the width direction.

It is to be noted that the series of resonators 510, 520, 530, 540 includes two (sub-)groups of resonators each comprising two resonators that are electromagnetically coupled to each other and having the following properties: The guide directions of the resonators of each group are aligned with each other and the resonators of the respective group are further arranged along the guide direction of a first one of the resonators of the group so that the second section of rectangular waveguide of the first resonator faces the second section of rectangular waveguide of the second resonator of the respective group. The second section of rectangular waveguide of the first resonator is electromagnetically coupled to the second section of rectangular waveguide of the second resonator. Specifically, the groups are formed by the first and second resonators 510, 520, and by the third and fourth resonators 530, 540, respectively, of the filter 500. Such a group of resonators can be used as a further basic building block in more complex filter implementations. One example of such an implementation is the rectangular waveguide filter 500 of the third embodiment itself.

Further, the series of resonators 510, 520, 530, 540 includes a (sub-) group of resonators comprising two resonators that are electromagnetically coupled to each other and having the following properties: The guide directions of the resonators of the group are aligned with each other, and the resonators of the group are further arranged along the guide direction of a first one of the resonators of the group so that the first section of rectangular waveguide of the first resonator faces the first section of rectangular waveguide of the second resonator of the group. The first section of rectangular waveguide of the first resonator is electromagnetically coupled to the first section of rectangular waveguide of the second resonator. Specifically, the group is formed by the second and third resonators 520, 530 of the filter 500. Such a group of resonators can be used as a further basic building block in more complex filter implementations. One example of such an implementation is the rectangular waveguide filter 500 of the third embodiment itself.

FIG. 5D is a horizontal cut through the rectangular waveguide filter 500 of the second embodiment, wherein the cutting plane has been chosen so as to extend through the second sections of rectangular waveguide 512, 522, 532, 542 of the first to fourth resonators 510, 520, 530, 540.

While it has been stated above that each of the resonators 510, 520, 530, 540 of the filter 500 is a resonator according to the first embodiment, instead of resonators according to the first embodiment (i.e., SLERW resonators), also resonators according to the second embodiment (i.e., ALERW resonators) may be used. In this case it is understood that every other of the resonators is rotated by 180 degrees about a rotation axis extending in the height direction.

FIG. 5E illustrates the electrical performance of the rectangular waveguide filter 500 of FIGS. 5A to 5D. The abscissa indicates the frequency in units of GHz and the ordinate indicates the S-parameter of the rectangular waveguide filter in units of dB. Graph 591 indicates the S21-component of the S-parameter, and graph 592 indicates the S11-component of the S-parameter. For reasons of symmetry, S11=S22 and S21=S12 hold for the rectangular waveguide filter 500. As can be seen from FIG. 5E, S11 has four poles in the passband indicated by S21 (in the figure at about 15.56, 15.75, 15.96, and 16.13 GHz).

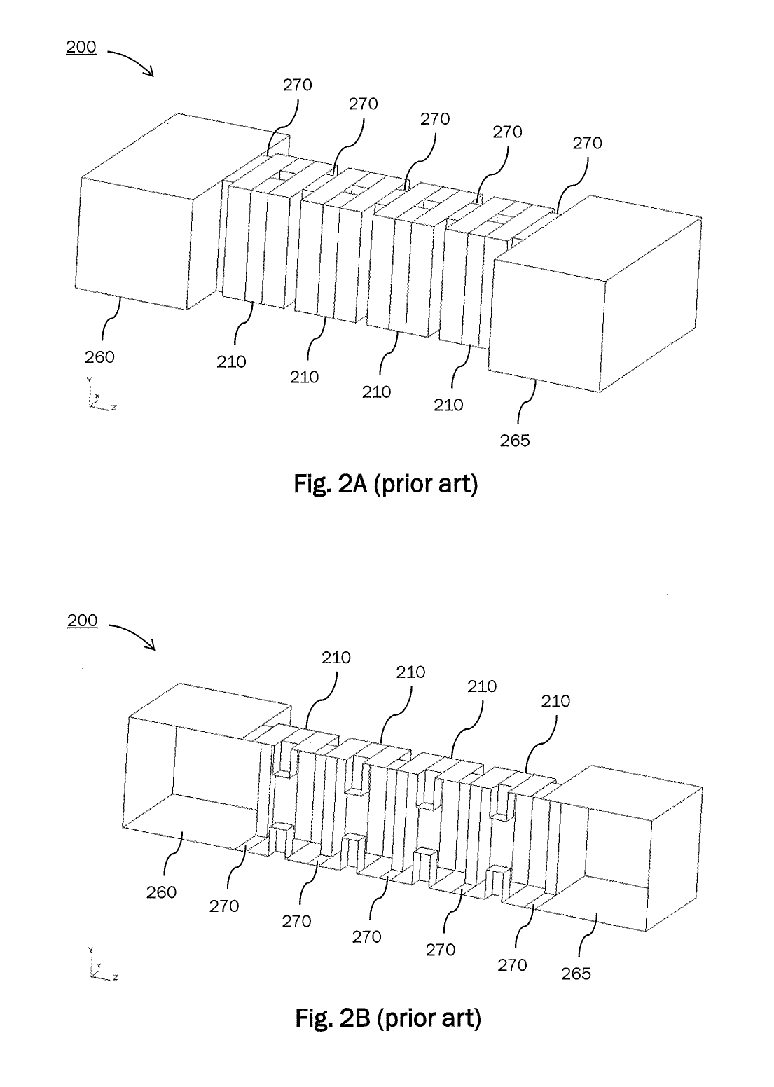

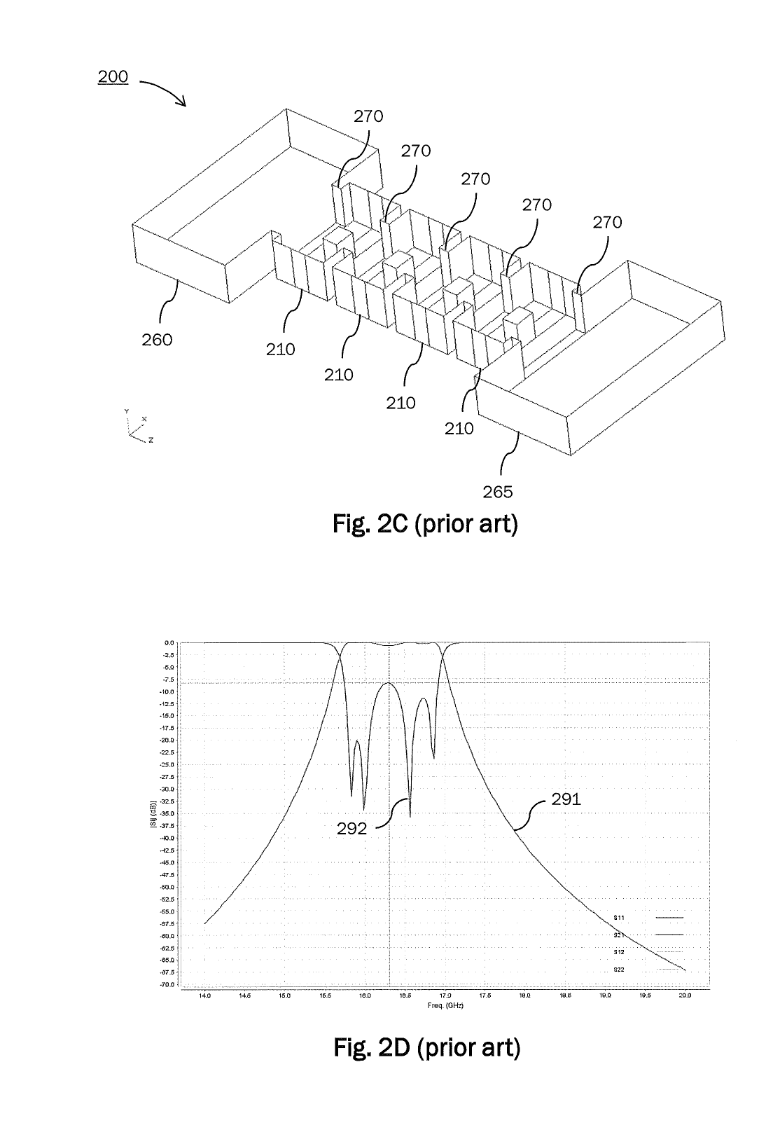

As can be seen from a comparison of FIGS. 1D, 2D, and 5E, the rectangular waveguide filter 500 of the third embodiment is similar in electrical performance to the conventional four pole inductive filter illustrated in FIGS. 1A to 1C, and to the conventional four pole ridge resonator filter illustrated in FIGS. 2A to 2C. While the electrical performance is not completely identical, it is to be noted that the remaining differences in electrical performance could be removed by a fine tuning of the lengths of the respective filters in terms of tens of microns of variation in length.

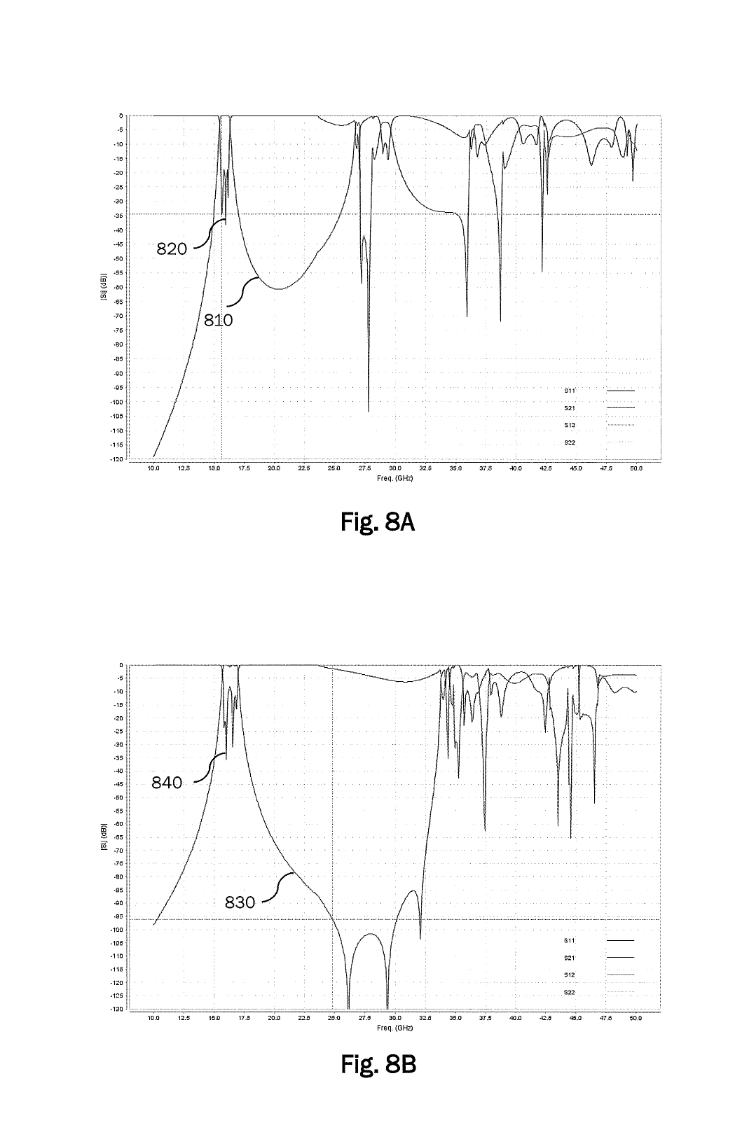

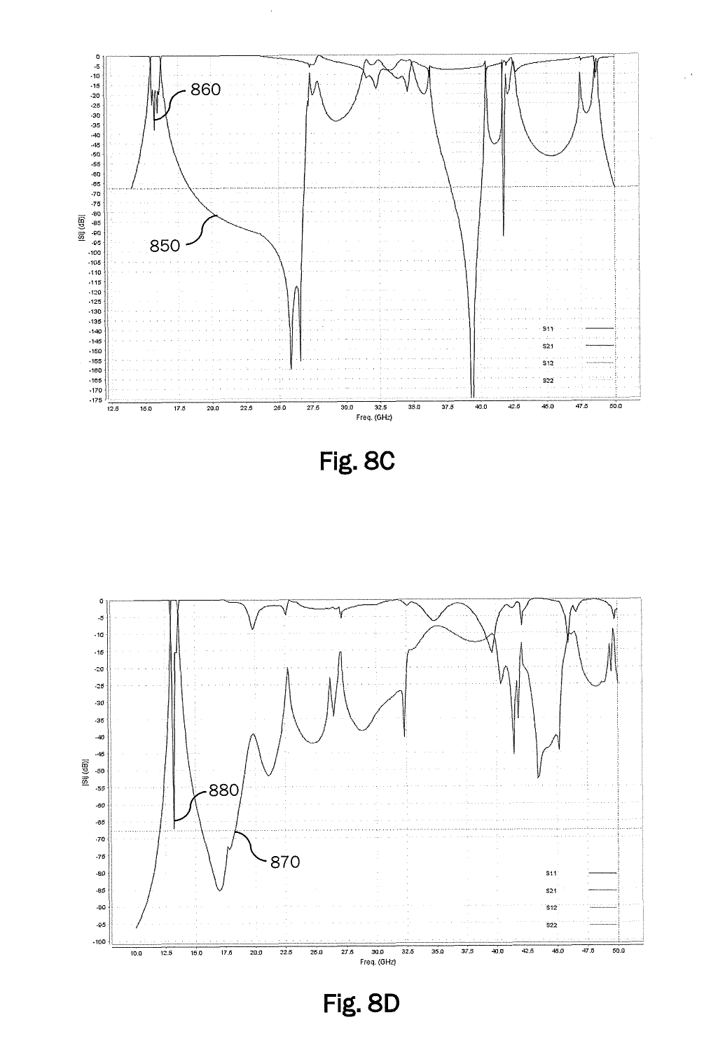

Referring now to FIGS. 8A to 8C, the out-of-band performance of the rectangular waveguide filter 500 (SLERW filter; cf. FIG. 8C) will be compared to those of an equivalent inductive filter (cf. FIG. 8A) and an equivalent ridge resonator filter (cf. FIG. 8B). In each of these figures, the abscissa indicates the frequency in units of GHz and the ordinate indicates the S-parameter of the respective filter in units of dB. Graphs 810, 830, 850 indicate the S21-component of the S-parameter, and graphs 820, 840, 860 indicate the S11-component of the S-parameter. For reasons of symmetry, S11=S22 and S21=S12 holds for the respective filters. As can be seen from FIGS. 8A and 8B, the conventional four pole inductive filter and the conventional four pole ridge resonator filter have maximum values of out-of-band rejection of −60 dB and more than −100 dB, respectively. Also the SLERW filter, as can be seen from FIG. 8C, achieves maximum out-of-band rejection that is better than −100 dB. Thus, as was the case for the maximum bandwidth, also with regard to the out-of-band rejection, it is found that the SLERW filter achieves a performance that is between those of equivalent inductive filters and equivalent ridge resonator filters.

A further important property of microwave filters is their insertion loss. It is a known fact that the insertion loss of a microwave resonator depends, at a given frequency, on the volume of the resonator. Comparing the filter structures of the inductive filter, the ridge resonator filter and the SLERW filter described above, it is then expected that the insertion loss of the SLERW filter will be not as good as that of equivalent inductive filters, but will be better than that of equivalent ridge resonator filters.

Lastly, the high power performance of the SLERW filter will be considered. It is found that the electric field intensity in the SLERW filter is slightly more than double the electric field intensity in an equivalent inductive filter but it is almost half the electric field intensity in an equivalent ridge resonator filter. This is a clear indication that the SLERW filter will be able to withstand significantly higher power levels as compared to equivalent ridge resonator filters.

On the other hand, the filter configuration of the third embodiment allows for a significant length reduction compared to an equivalent inductive filter. In the inventor's tests, the inductive filter 100 (cf. FIGS. 1A to 1C), the ridge resonator filter 200 (cf. FIGS. 2A to 2C) and the SLERW filter 500 of the third embodiment (cf. FIGS. 5A to 5D) have been compared with regard to their lengths. It was found that for a reference length of the inductive filter of about 43.24 mm, the equivalent ridge resonator filter had a length of about 27.00 mm and the equivalent SLERW filter had a length of about 34.15 mm. Thus, the SLERW filter achieves a length reduction by about 21%. While the length of the ridge resonator filter 200 is even reduced by about 37.6% compared to the reference length, it has been found that this reduction comes at the price of diminished maximum possible power levels, higher insertion losses, and more complicated manufacture of the ridge resonator filter 200.

Summarizing, the SLERW filter 500 of the third embodiment offers significant length reduction compared to an equivalent inductive filter at justifiable trade-off with regard to filter performance.

As indicated above, although the filters illustrated in FIGS. 1A, 2A, and 5A are not exactly identical as regards their electrical performance (cf. FIGS. 1D, 2D, and 5E), their total length is fully indicative of the order of magnitude of the miniaturization that can be achieved. The reason is that what would be needed in order to make the filters exactly identical in electrical performance would be a fine tuning in terms of tens of microns of variation in length.

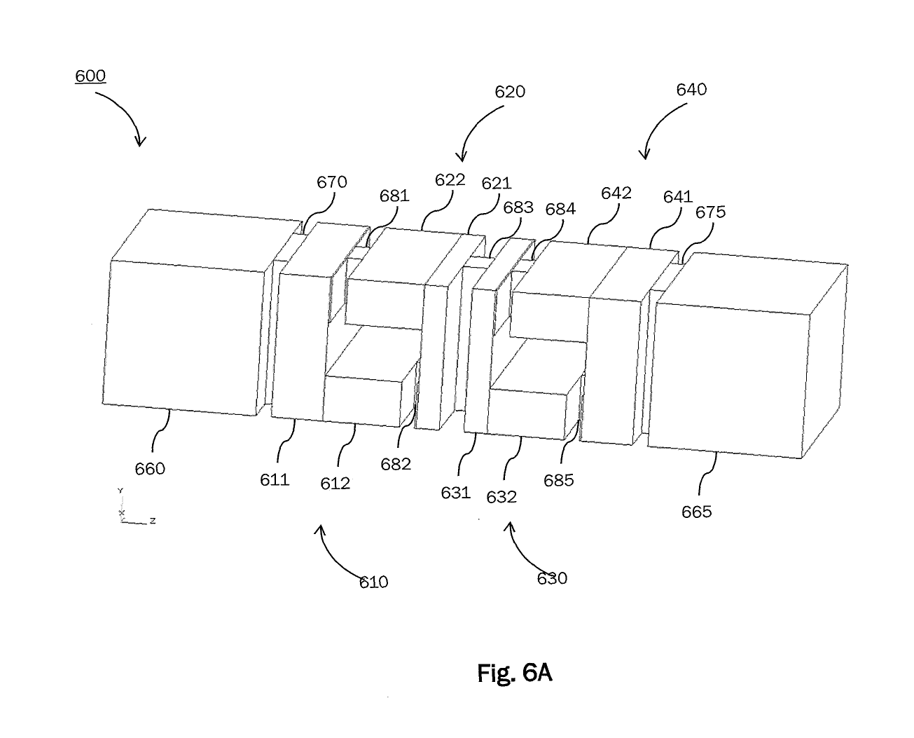

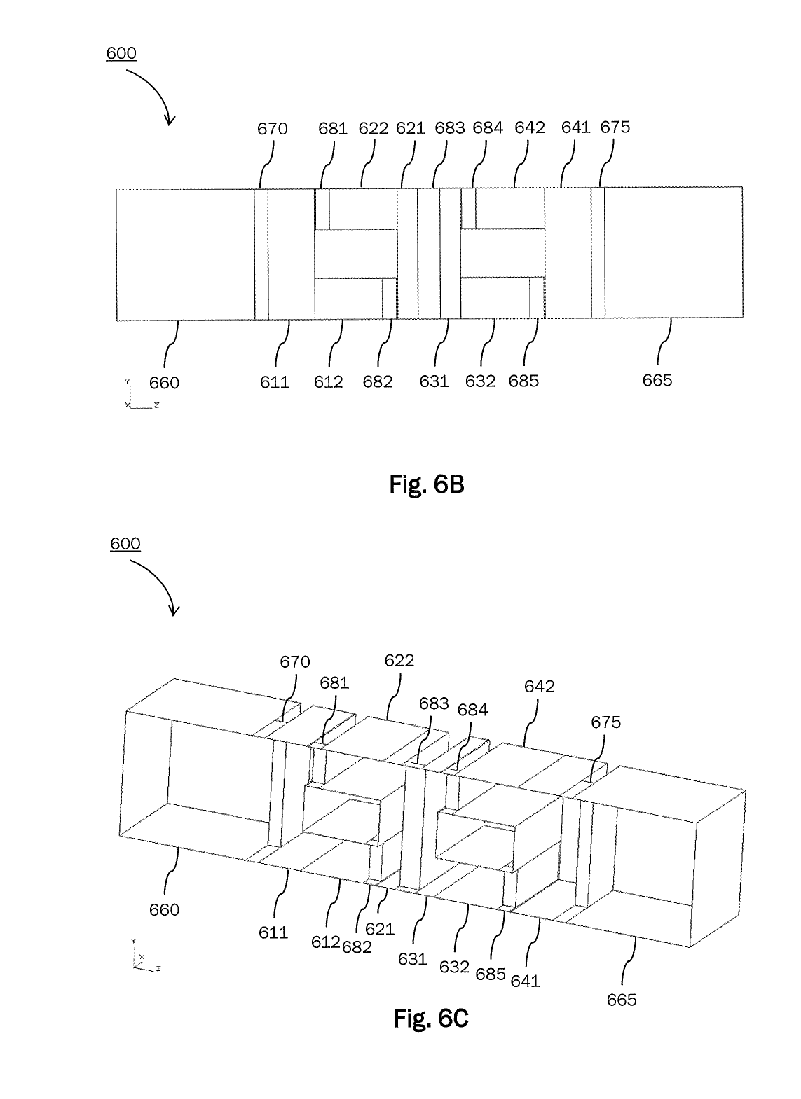

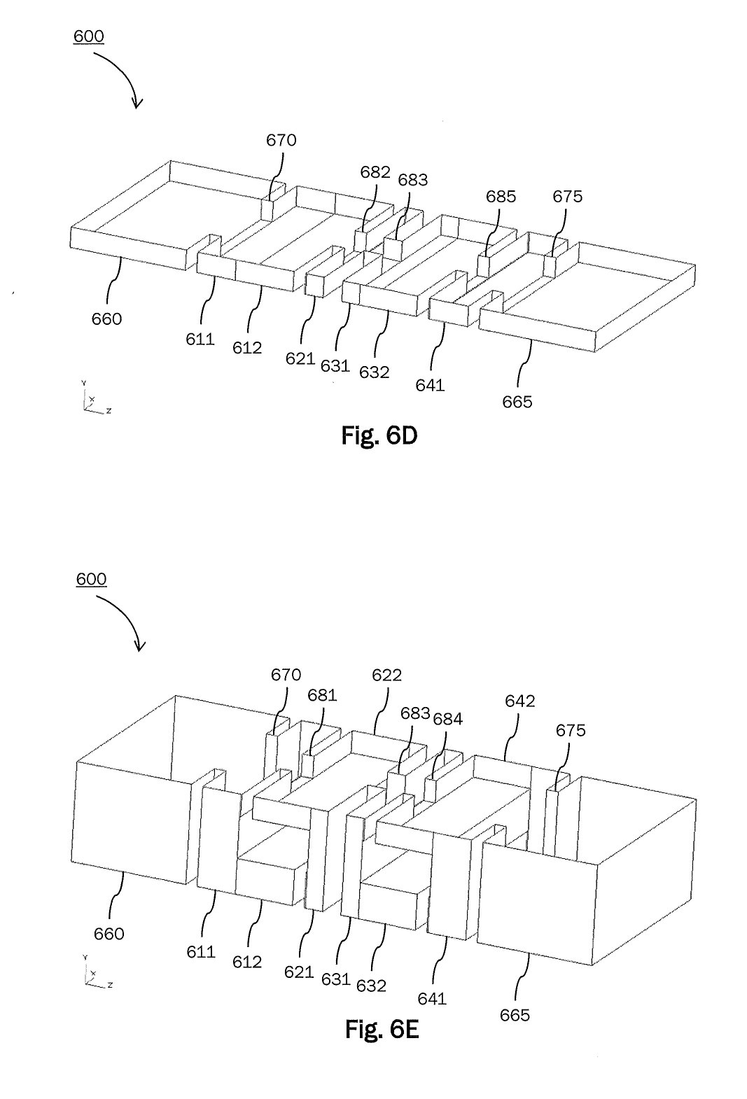

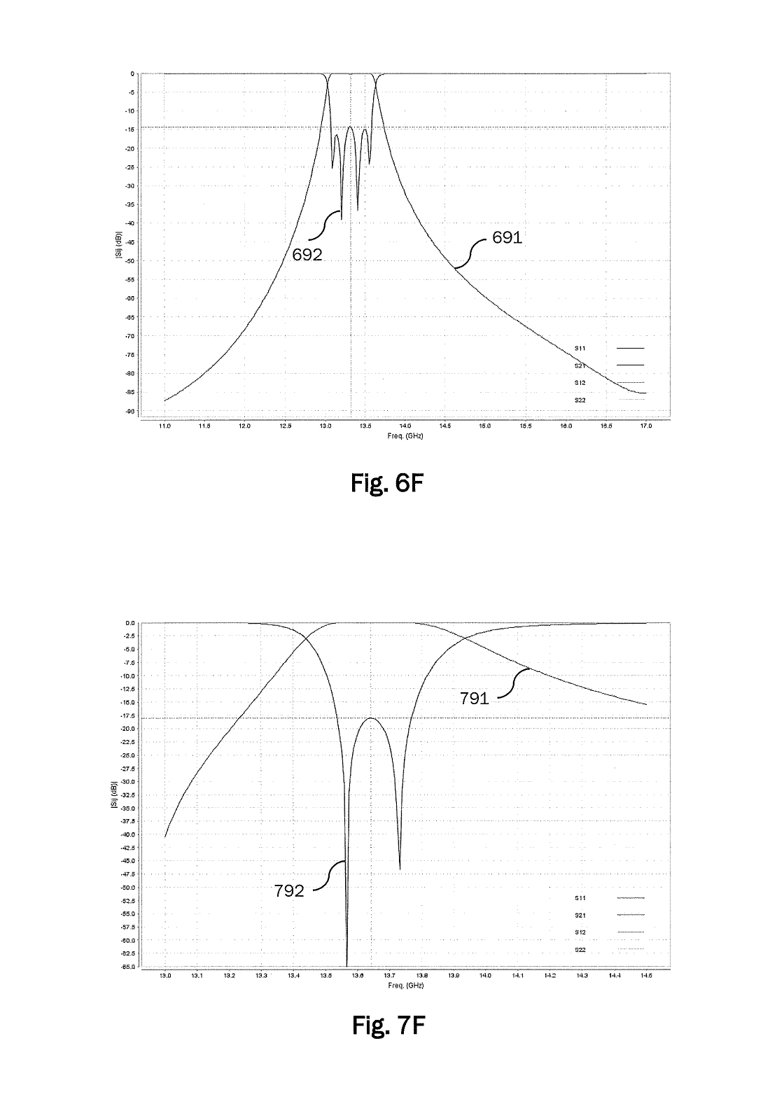

Next, a rectangular waveguide filter 600 according to a fourth embodiment of the present disclosure will be described with reference to FIGS. 6A to 6F. FIG. 6A is a perspective view of the rectangular waveguide filter 600 according to the fourth embodiment of the present disclosure, FIG. 6B is a lateral view of the rectangular waveguide filter 600, FIG. 6C is a sagittal cut (i.e., a cut along the y-z-plane) through the rectangular waveguide filter 600, FIG. 6D is a first horizontal cut (i.e., a cut along the x-z-plane) through the rectangular waveguide filter 600, FIG. 6E is a second horizontal cut through the rectangular waveguide filter 600, and FIG. 6F illustrates the electrical performance of the rectangular waveguide filter 600.

The rectangular waveguide filter 600 illustrated in FIGS. 6A to 6E comprises a series of first to fourth resonators 610, 620, 630, 640, each of which is a resonator according to the second embodiment (cf. FIGS. 4A to 4D). Therefore, each of the first to fourth resonators 610, 620, 630, 640 comprises a first section of rectangular waveguide 611, 621, 631, 641 and a second section of rectangular waveguide 612, 622, 632, 642.

In the rectangular waveguide filter 600 illustrated in FIGS. 6A to 6E, the widths of the first to fourth resonators 610, 620, 630, 640 are identical. Moreover, the first sections of rectangular waveguide 611, 621, 631, 641 have identical height, and the second sections of rectangular waveguide 612, 622, 632, 642 have identical height. However, the electric lengths of the first sections of rectangular waveguide 611, 621, 631, 641 may be different from each other, and the electric lengths of the second sections of rectangular waveguide 612, 622, 632, 643 may be different from each other. In other words, each of the electric lengths of the first and second sections of the first to fourth resonators 610, 620, 630, 640, respectively, is a design parameter that may be chosen independently from the other design parameters in accordance with filter requirements.

In a preferred embodiment, the electric lengths of the first sections of rectangular waveguide 611, 641 of the first and fourth resonators 610, 640 are identical, and the electric lengths of the first sections of rectangular waveguide 621, 631 of the second and third resonators 620, 630 are identical. Moreover, in the preferred embodiment, the electric lengths of the second sections of rectangular waveguide 612, 642 of the first and fourth resonators 610, 640 are identical, and the electric lengths of the second sections of rectangular waveguide 621, 631 of the second and third resonators 620, 630 are identical. In a further preferred embodiment, the first to fourth resonators 610, 620, 630, 640 are identical resonators, i.e., their widths, heights, and electric lengths are identical.

The series of resonators 610, 620, 630, 640 is interposed between an input port 660 and an output port 665. The first resonator 610 of the series of resonators is coupled to the input port 660 through a first coupling section 670, and the fourth resonator 640 of the series of resonators is coupled to the output port 665 through a second coupling section 675. Exemplarily, inductive coupling sections (inductive coupling windows or inductive coupling irises) are illustrated as the first and second coupling sections 670, 675. However, instead of inductive coupling sections, also alternative coupling sections that are readily apparent to persons of ordinary skill in the art can be used for coupling the first and fourth resonators 610, 640 to the input and output ports 660, 665, respectively, e.g., capacitive coupling sections (capacitive coupling windows or capacitive coupling irises) or hybrid coupling sections (hybrid coupling windows or hybrid coupling irises).

The first to fourth resonators 610, 620, 630, 640 are arranged along the guide direction of the filter 600, wherein the center axes of the first sections of rectangular waveguide 611, 621, 631, 641 of the first to fourth resonators 610, 620, 630, 640 extend in parallel to each other and are aligned with each other. Moreover, the first to fourth resonators 610, 620, 630, 640 are oriented so that their width directions and height directions, respectively, extend in parallel to each other. In other words, corresponding broad walls of the four first sections of rectangular waveguide 611, 621, 631, 641 are aligned with each other, corresponding narrow walls of the four first sections of rectangular waveguide 611, 621, 631, 641 are aligned with each other, and corresponding narrow walls of the four second sections of rectangular waveguide 612, 622, 632, 642 are aligned with each other. As indicated above, the widths and heights of the first to fourth resonators 610, 620, 630, 640 are identical.

The first section of rectangular waveguide 611 of the first resonator 610 is coupled to the input port 660 through the first coupling section 670. On its opposite end along its guide direction, the first section of rectangular waveguide 611 of the first resonator 610 is coupled to the second section of rectangular waveguide 622 of the second resonator 620 through a first intermediate coupling section 681. The second section of rectangular waveguide 612 of the first resonator 610 is coupled to the first section of rectangular waveguide 621 of the second resonator 620 through a second intermediate coupling section 682. On its opposite end along its guide direction, the first section of rectangular waveguide 621 of the second resonator 620 is coupled to the first section of rectangular waveguide 631 of the third resonator 630 through a third intermediate coupling section 683. On its opposite end along its guide direction, the first section of rectangular waveguide 631 of the third resonator 630 is coupled to the second section of rectangular waveguide 642 of the fourth resonator through a fourth intermediate coupling section 684. The second section of rectangular waveguide 632 of the third resonator 630 is coupled to the first section of rectangular waveguide 641 of the fourth resonator 640 through a fifth intermediate coupling section 685. On its other end along its guide direction, the first section of rectangular waveguide 641 of the fourth resonator 640 is coupled to the output port 665 through the second coupling section 675.

Exemplarily, inductive coupling sections (inductive coupling windows or inductive coupling irises) are illustrated as the first to fifth intermediate coupling sections 681-685. However, instead of inductive coupling sections, also alternative coupling sections that are readily apparent to persons of ordinary skill in the art can be used for coupling the first to fourth resonators 610, 620, 630, 640 to each other, respectively, e.g., capacitive coupling sections (capacitive coupling windows or capacitive coupling irises) or hybrid coupling sections (hybrid coupling windows or hybrid coupling irises).

As follows from the above description of the rectangular waveguide filter 600 of the fourth embodiment, the guide directions of the first through fourth resonators 610, 620, 630, 640 (i.e., the guide directions of their first sections of rectangular waveguide 611, 621, 631, 641 are aligned with each other and the first through fourth resonators 610, 620, 630, 640 are arranged along a guide direction of the first resonator 610. The second and fourth resonators 620, 640 are rotated with respect to the first and third resonators 610, 630 by 180 degrees around rotation axes extending in the width direction. Further, the first through fourth resonators 610, 620, 630, 640 are arranged so that the second section of rectangular waveguide 612 of the first resonator 610 faces a part of the first section of rectangular waveguide 621 of the second resonator 620, the second section of rectangular waveguide 622 of the second resonator 620 faces a part of the first section of rectangular waveguide 611 of the first resonator 610, the second section of rectangular waveguide 632 of the third resonator 630 faces a part of the first section of rectangular waveguide 641 of the fourth resonator 640, and the second section of rectangular waveguide 642 of the fourth resonator 640 faces a part of the first section of rectangular waveguide 631 of the third resonator 630. Further, those ends of the first sections of rectangular waveguide 621, 631 of the second and third resonators 620, 630 opposite to respective ends at which the first sections of rectangular waveguide 621, 631 are joined to respective second sections of rectangular waveguide 622, 632, are facing each other.

Moreover, the second section of rectangular waveguide 622 of the second resonator 620 is electromagnetically coupled to the first section of rectangular waveguide 611 of the first resonator 610, the second section of rectangular waveguide 612 of the first resonator 610 is electromagnetically coupled to the first section of rectangular waveguide 621 of the second resonator 620, the second section of rectangular waveguide 642 of the fourth resonator 640 is electromagnetically coupled to the first section of rectangular waveguide 631 of the third resonator 630, the second section of rectangular waveguide 632 of the third resonator 630 is electromagnetically coupled to the first section of rectangular waveguide 641 of the fourth resonator 640, and the first section of rectangular waveguide 621 of the second resonator 620 is further electromagnetically coupled to the first section of rectangular waveguide 631 of the third resonator 630.

It is to be noted that the series of resonators 610, 620, 630, 640 includes two (sub-)groups of resonators each comprising two resonators that are electromagnetically coupled to each other and having the following properties: The guide directions of the resonators of each group are aligned with each other and the resonators of the respective group are further arranged along the guide direction of a first one of the resonators of the group so that the second section of rectangular waveguide of the first resonator faces a part of the first section of rectangular waveguide of the second resonator of the group, and the second section of rectangular waveguide of the second resonator faces a part of the first section of rectangular waveguide of the first resonator. The second section of rectangular waveguide of the second resonator is electromagnetically coupled to the first section of rectangular waveguide of the first resonator and the second section of rectangular waveguide of the first resonator is electromagnetically coupled to the first section of rectangular waveguide of the second resonator. In a preferred embodiment of the group, the first resonator and the second resonator are arranged so that, when seen in a viewing direction extending along the height direction, the second section of rectangular waveguide of the first resonator overlaps with the second section of rectangular waveguide of the second resonator.

Specifically, the groups are formed by the first and second resonators 610, 620, and by the third and fourth resonators 630, 640, respectively, of the filter 600. Such a group can be used as a further basic building block in more complex filter implementations. One example of such an implementation is the rectangular waveguide filter 600 of the fourth embodiment itself. Another example is the rectangular waveguide filter 700 of the fifth embodiment presented below.

FIGS. 6D and 6E are horizontal cuts through the rectangular waveguide filter 600. Therein, the cutting plane of FIG. 6D has been chosen so as to extend through the second sections of rectangular waveguide 612, 632 of the first and third resonators 610, 630, and the cutting plane of FIG. 6E has been chosen so as to extend through the second sections of rectangular waveguide 622, 642 of the second and fourth resonators 620, 640.

FIG. 6F illustrates the electrical performance of the rectangular waveguide filter 600 of FIGS. 6A to 6E. The abscissa indicates the frequency in units of GHz and the ordinate indicates the S-parameter of the rectangular waveguide filter in units of dB. Graph 691 indicates the S21-component of the S-parameter, and graph 692 indicates the S11-component of the S-parameter. For reasons of symmetry, S11=S22 and S21=S12 hold for the rectangular waveguide filter 600. As can be seen from FIG. 6F, S11 has four poles in the passband indicated by S21 (in the figure at about 13.09, 13.21, 13.41, and 13.56 GHz).

As can be seen from a comparison of FIGS. 1D, 2D and 6F, the rectangular waveguide filter 600 of the fourth embodiment is similar in electrical performance to the conventional four pole inductive filter illustrated in FIGS. 1A to 1C, and to the conventional four pole ridge resonator filter illustrated in FIGS. 2A to 2C. While the electrical performance is not completely identical, it is to be noted that the remaining differences in electrical performance could be removed by a fine tuning of the lengths of the respective filters in terms of tens of microns of variation in length.

Referring now to FIGS. 8A, 8B, and 8D, the out-of-band performance of the rectangular waveguide filter 600 (ALERW filter; cf. FIG. 8D) will be compared to those of an equivalent inductive filter (cf. FIG. 8A) and an equivalent ridge resonator filter (cf. FIG. 8B). In each of these figures, the abscissa indicates the frequency in units of GHz and the ordinate indicates the S-parameter of the respective filter in units of dB. Graphs 810, 830, 870 indicate the S21-component of the S-parameter, and graphs 820, 840, 880 indicate the S11-component of the S-parameter. For reasons of symmetry, S11=S22 and S21=S12 holds for the respective filters. As indicated above, the conventional four pole inductive filter and the conventional four pole ridge resonator filter have maximum values of out-of-band rejection of about −60 dB and better than −100 dB, respectively. The ALERW filter, as can be seen from FIG. 8D, achieves maximum out-of-band rejection that is slightly better than −80 dB. Thus, as was the case for the maximum bandwidth, also with regard to the out-of-band rejection, it is found that the ALERW filter achieves a performance that is between those of equivalent inductive filters and equivalent ridge resonator filters.

Comparing the filter structures of the inductive filter, the ridge resonator filter and the ALERW filter described above, it is expected that the insertion loss of the ALERW filter will be not as good as that of equivalent inductive filters, but will be better than that of equivalent ridge resonator filters.

As regards the high power performance of the ALERW filter, it is found that the electric field intensity in the ALERW filter is slightly more than double the electric field intensity in an equivalent inductive filter but it is almost half the electric field intensity in an equivalent ridge resonator filter. This is a clear indication that the ALERW filter will be able to withstand significantly higher power levels as compared to equivalent ridge resonator filters.

On the other hand, the filter configuration of the fourth embodiment allows for a significant length reduction compared to an equivalent inductive filter. In the inventor's tests, the inductive filter 100 (cf. FIGS. 1A to 1C), the ridge resonator filter 200 (cf. FIGS. 2A to 2C) and the ALERW filter 600 of the fourth embodiment (cf. FIGS. 6A to 6E) have been compared with regard to their lengths. It was found that for a reference length of the inductive filter of about 43.24 mm, the equivalent ridge resonator filter had a length of about 27.00 mm and the ALERW filter had a length of about 25.70 mm. Thus, the ALERW filter achieves a length reduction by about 40.6%. This surpasses the length reduction of about 37.6% compared to the reference length attainable by the ridge resonator filter 200. Yet, the ALERW filter has higher sustainable maximum possible power levels and lower insertion losses, and is less complicated to manufacture than the ridge resonator filter 200.

Summarizing, the ALERW filter of the fourth embodiment offers significant length reduction compared to an equivalent inductive filter that is better than that attainable by a ridge resonator filter at justifiable trade-off with regard to filter performance.

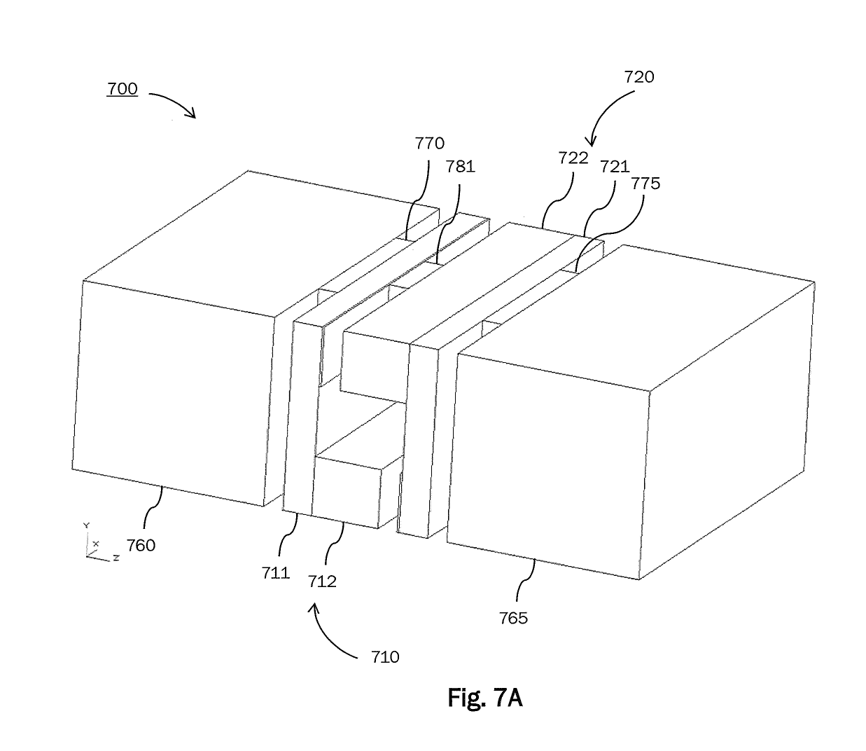

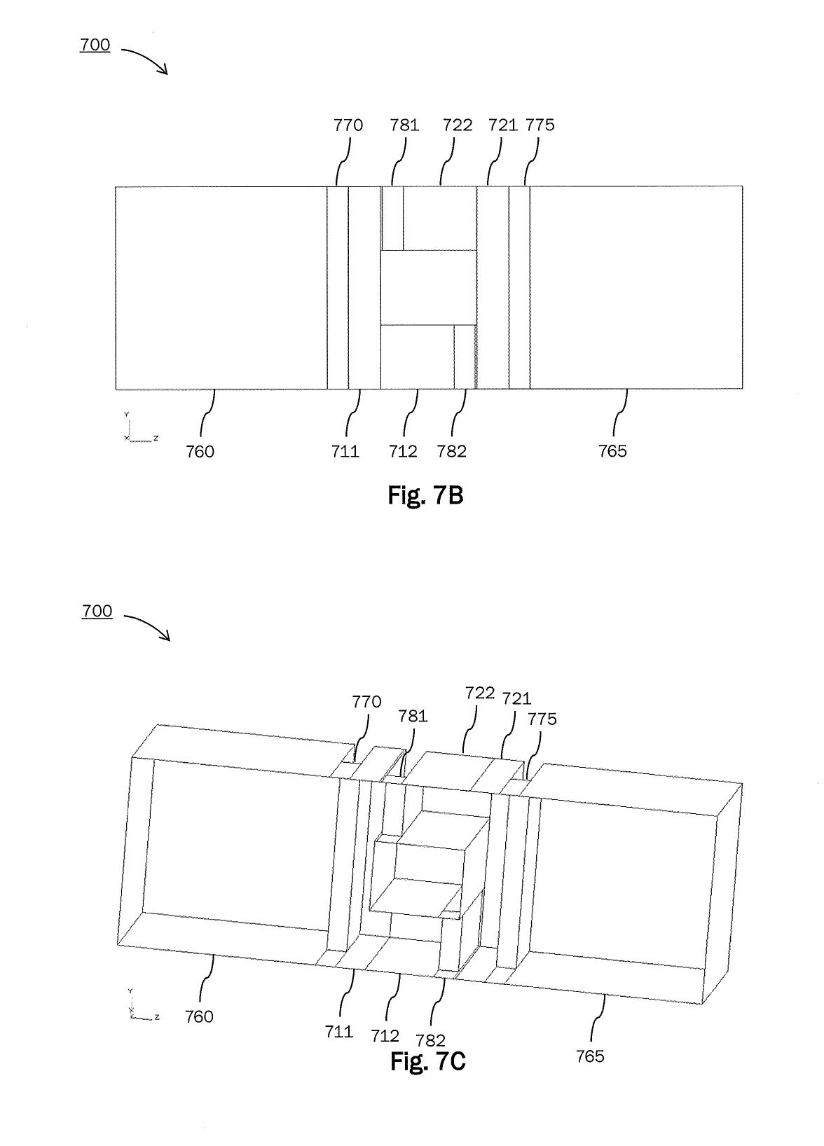

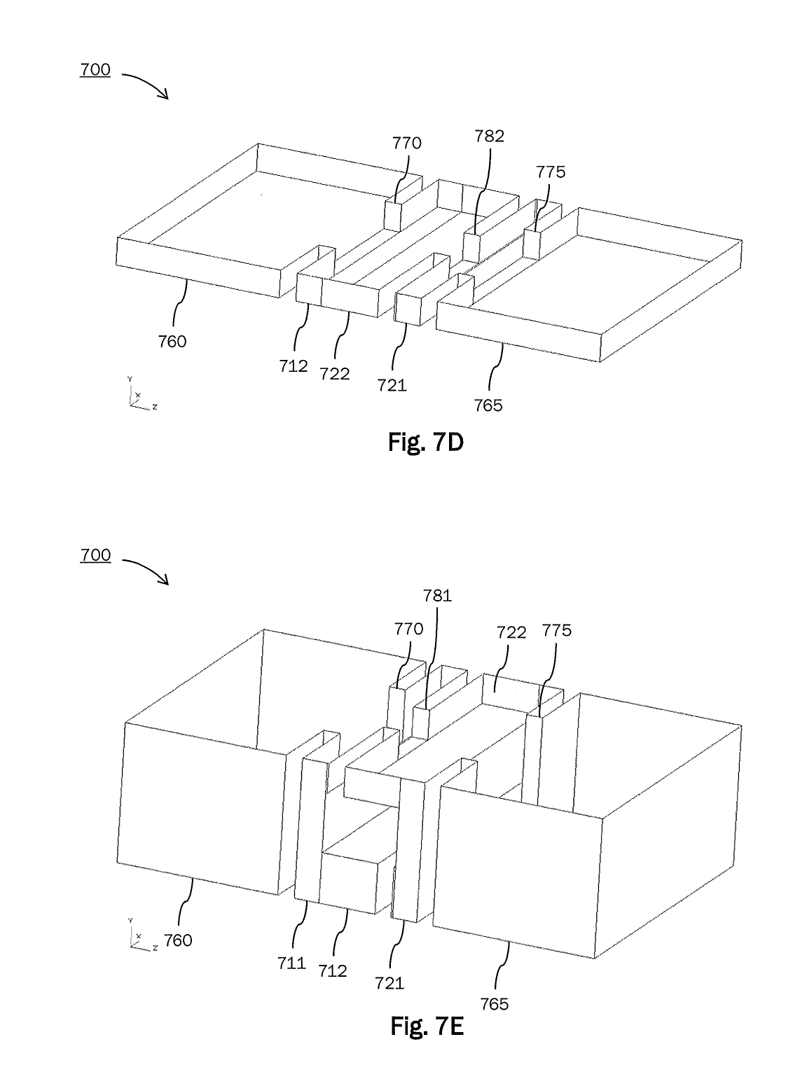

An additional advantage of the new family of filters described in the present disclosure is that they can very easily take advantage of dielectric loading, which results in a further reduction of the filter dimensions. A rectangular waveguide filter 700 using dielectric loading according to a fifth embodiment of the present disclosure will now be described with reference to FIGS. 7A to 7F. FIG. 7A is a perspective view of the rectangular waveguide filter 700 according to the fifth embodiment of the present disclosure, FIG. 7B is a lateral view of the rectangular waveguide filter 700, FIG. 7C is a sagittal cut (i.e., a cut along the y-z-plane) through the rectangular waveguide filter 700, FIG. 7D is a first horizontal cut (i.e., a cut along the x-z-plane) through the rectangular waveguide filter 700, FIG. 7E is a second horizontal cut through the rectangular waveguide filter 700, and FIG. 7F illustrates the electrical performance of the rectangular waveguide filter 700.

The rectangular waveguide filter 700 illustrated in FIGS. 7A to 7E comprises a first resonator 710 and a second resonator 720, each of which is a resonator according to the second embodiment (cf. FIGS. 4A to 4D). Therefore, each of the first and second resonators 710, 720 comprises a first section of rectangular waveguide 711, 721 and a second section of rectangular waveguide 712, 722.

In the rectangular waveguide filter 700 illustrated in FIGS. 7A to 7E, the widths of the first and second resonators 710, 720 are identical. Moreover, the first sections of rectangular waveguide 711, 721 have identical height, and the second sections of rectangular waveguide 712, 722 have identical height. However, the electric lengths of the first sections of rectangular waveguide 711, 721 may be different from each other, and the electric lengths of the second sections of rectangular waveguide 712, 722, may be different from each other. In other words, each of the electric lengths of the first and second sections of the first and second resonators 710, 720, respectively, is a design parameter that may be chosen independently from the other design parameters in accordance with filter requirements.

In a preferred embodiment, for reasons of symmetry, the electric lengths of the first sections of rectangular waveguide 711, 721 of the first and second resonators 710, 720 are identical, and the electric lengths of the second sections of rectangular waveguide 712, 722 of the first and second resonators 710, 720 are identical. Thus, in the preferred embodiment, the first and second resonators 710, 720 are identical.

The first and second resonators 710, 720 are interposed between an input port 760 and an output port 765. The first resonator 710 is coupled to the input port 760 through a first coupling section 770, and the second resonator 720 is coupled to the output port 765 through a second coupling section 775. Exemplarily, inductive coupling sections (inductive coupling windows or inductive coupling irises) are illustrated as the first and second coupling sections 770, 775. However, instead of inductive coupling sections, also alternative coupling sections that are readily apparent to persons of ordinary skill in the art can be used for coupling the first and second resonators 710, 720 to the input and output ports 760, 765, respectively, e.g., capacitive coupling sections (capacitive coupling windows or capacitive coupling irises) or hybrid coupling sections (hybrid coupling windows or hybrid coupling irises).

The first and second resonators 710, 720 are arranged along the guide direction of the filter 700, wherein the center axes of the first sections of rectangular waveguide 711, 721 of the first and second resonators 710, 720 extend in parallel to each other and are aligned with each other. Moreover, the first and second resonators 710, 720 are oriented so that their width directions and height directions, respectively, extend in parallel to each other. In other words, corresponding broad walls of the two first sections of rectangular waveguide 711, 721 are aligned with each other, corresponding narrow walls of the two first sections of rectangular waveguide 711, 721 are aligned with each other, and corresponding narrow walls of the two second sections of rectangular waveguide 712, 722 are aligned with each other. As indicated above, the widths and heights of the first and second resonators 710, 720 are identical.

The first section of rectangular waveguide 711 of the first resonator 710 is coupled to the input port 760 through the first coupling section 770. On its opposite end along its guide direction, the first section of rectangular waveguide 711 of the first resonator 710 is coupled to the second section of rectangular waveguide 722 of the second resonator 720 through a first intermediate coupling section 781. The second section of rectangular waveguide 712 of the first resonator 710 is coupled to the first section of rectangular waveguide 721 of the second resonator 720 through a second intermediate coupling section 782. On its other end along its guide direction, the first section of rectangular waveguide 721 of the second resonator 720 is coupled to the output port 765 through the second coupling section 775.

Exemplarily, inductive coupling sections (inductive coupling windows or inductive coupling irises) are illustrated as the first and second intermediate coupling sections 781, 782. However, instead of inductive coupling sections, also alternative coupling sections that are readily apparent to persons of ordinary skill in the art can be used for coupling the first and second resonators 710, 720 to each other, respectively, e.g., capacitive coupling sections (capacitive coupling windows or capacitive coupling irises) or hybrid coupling sections (hybrid coupling windows or hybrid coupling irises).

As follows from the above description of the rectangular waveguide filter 700 of the fifth embodiment, the guide directions of the first and second resonators 710, 720 (i.e., the guide directions of their first sections of rectangular waveguide 711, 721 are aligned with each other and the first and second resonators 710, 720 are arranged along a guide direction of the first resonator 710. The second resonator 720 is rotated with respect to the first resonator 710 by 180 degrees around a rotation axis extending in the width direction. Further, the first and second resonators 710, 720 are arranged so that the second section of rectangular waveguide 712 of the first resonator 710 faces a part of the first section of rectangular waveguide 721 of the second resonator 720, and the second section of rectangular waveguide 722 of the second resonator 720 faces a part of the first section of rectangular waveguide 711 of the first resonator 710. Moreover, the second section of rectangular waveguide 722 of the second resonator 720 is electromagnetically coupled to the first section of rectangular waveguide 711 of the first resonator 710, and the second section of rectangular waveguide 712 of the first resonator 710 is electromagnetically coupled to the first section of rectangular waveguide 721 of the second resonator 720.

It is to be noted that the first and second resonators 710, 720 form a (sub-)group as discussed above in connection with the filter 600 of the fourth embodiment.

FIGS. 7D and 7E are horizontal cuts through the rectangular waveguide filter 700. Therein, the cutting plane of FIG. 7D has been chosen so as to extend through the second section of rectangular waveguide 712 of the first resonator 710, and the cutting plane of FIG. 7E has been chosen so as to extend through the second section of rectangular waveguide 722 of the second resonator 720.

In the fifth embodiment, the capacitive sections (i.e., second sections of rectangular waveguide) of the first and second resonators 710, 720 are loaded with a dielectric. For the purpose of the below description, it will be assumed that the dielectric constant of the dielectric is equal to 2.0.

As indicated above, by virtue of its simplified structure and manufacturability, dielectric loading can be conveniently applied to the filters according to the present disclosure. It has been found by the inventor that by dielectric loading of the capacitive sections, the length of a filter (with geometric structure according to the fifth embodiment) can be further reduced by more than 20%. In an exemplary implementation, the length of the loaded filter was found to be about 9.55 mm, whereas the length of an equivalent filter without loading would have been about 12.1 mm. This corresponds to a further length reduction of about 21% on top of the length reduction described above.

It is understood that also the inductive sections (i.e., the first sections of rectangular waveguide) may be loaded instead of, or in addition to, the capacitive sections. Moreover, of course also the capacitive and/or inductive sections of the filters of the further embodiments of the present disclosure may be loaded. In these cases, length reductions similar to the one discussed above can be achieved.

FIG. 7F illustrates the electrical performance of the rectangular waveguide filter 700 of FIGS. 7A to 7E. The abscissa indicates the frequency in units of GHz and the ordinate indicates the S-parameter of the rectangular waveguide filter in units of dB. Graph 791 indicates the S21-component of the S-parameter, and graph 792 indicates the S11-component of the S-parameter. For reasons of symmetry, S11=S22 and S21=S12 hold for the rectangular waveguide filter 700. As can be seen from FIG. 7F, S11 has two poles in the passband indicated by S21 (in the figure at about 13.58 and 13.74 GHz).

Summarizing, the present disclosure relates to a new family of rectangular waveguide bandpass filters based on a new resonator geometry referred to by the inventor as Lumped Element Rectangular Waveguide (LERW) resonators. The new resonator structure allows for a higher level of miniaturization of rectangular waveguide bandpass filters as compared to the current state-of-the-art (namely ridge resonator filters), while providing comparable out-of-band rejection performance, superior insertion loss, and better power performance. This new type of filter can be employed in practical applications both in ground and space systems.

Features, components and specific details of the structures of the above-described embodiments may be exchanged or combined to form further embodiments optimized for the respective application. As far as those modifications are readily apparent for a person of ordinary skill in the art, they shall be disclosed implicitly by the above description without specifying explicitly every possible combination, for the sake of conciseness of the present description.

1. A resonator for use in a rectangular waveguide filter, comprising a first section of rectangular waveguide and a second section of rectangular waveguide that are arranged along a guide direction of the resonator and joined to each other to form the resonator,
wherein walls of the second section of rectangular waveguide that extend in the guide direction are in a parallel relationship with respective walls of the first section of rectangular waveguide;
wherein a width of the first section of rectangular waveguide in a width direction is equal to a width of the second section of rectangular waveguide in the width direction so that the resonator has uniform width in the width direction, the width direction being defined by a broader one of dimensions of a transverse cross-section of the first section of rectangular waveguide; and
wherein a height of the second section of rectangular waveguide in a height direction is smaller than a height of the first section of rectangular waveguide in the height direction, the height direction being defined by a narrower one of the dimensions of the transverse cross-section of the first section of rectangular waveguide.

2. The resonator according to claim 1, wherein the height of the second section of rectangular waveguide is between one fifth and one third of the height of the first section of rectangular waveguide.

3. The resonator according to claim 1, wherein a length of the second section of rectangular waveguide in the guide direction is equal to or larger than a length of the first section of rectangular waveguide in the guide direction.

4. The resonator according to claim 1, wherein at least one of the first section of rectangular waveguide and the second section of rectangular waveguide is filled with a dielectric material.

5. The resonator according to claim 1, wherein the first and second sections of rectangular waveguide are arranged relative to each other so that a center axis of the second section of rectangular waveguide and a center axis of the first section of rectangular waveguide are aligned with each other, each center axis extending along the guide direction of the respective section of rectangular waveguide.

6. The resonator according to claim 1, wherein the second section of rectangular waveguide is arranged relative to the first section of rectangular waveguide so that a center axis of the second section of rectangular waveguide is shifted in the height direction relative to a center axis of the first section of rectangular waveguide, each center axis extending along the guide direction of the respective section of rectangular waveguide.

7. The resonator according to claim 6,
wherein the height of the second section of rectangular waveguide is at most half the height of the first section of rectangular waveguide; and
wherein the center axis of the second section of rectangular waveguide is shifted in the height direction relative to the center axis of the first section of rectangular waveguide by at least half the height of the second section of rectangular waveguide.

8. The resonator according to claim 6,
wherein the height of the second section of rectangular waveguide is at most half the height of the first section of rectangular waveguide; and
wherein one of lateral walls of the second section of rectangular waveguide that correspond to a broader one of dimensions of a transverse cross-section of the second section of rectangular waveguide is aligned with a respective one of lateral walls of the first section of rectangular waveguide that correspond to the broader one of dimensions of the transverse cross-section of the first section of rectangular waveguide.

9. A group of resonators for use in a rectangular waveguide filter, the group comprising a first resonator and a second resonator according to claim 1 that are electromagnetically coupled to each other,
wherein the guide directions of the first and second resonators are aligned with each other and the first resonator and the second resonator are arranged along the guide direction of the first resonator so that the second section of rectangular waveguide of the first resonator faces the second section of rectangular waveguide of the second resonator.

10. A group of resonators for use in a rectangular waveguide filter, the group comprising a first resonator and a second resonator according to claim 1 that are electromagnetically coupled to each other,
wherein the guide directions of the first and second resonators aligned with each other and the first resonator and the second resonator are arranged along the guide direction of the first resonator so that the first section of rectangular waveguide of the first resonator faces the first section of rectangular waveguide of the second resonator.

11. A group of resonators for use in a rectangular waveguide filter, the group comprising first through fourth resonators according to claim 1,
wherein the guide directions of the first through fourth resonators are aligned with each other and the first through fourth resonators are arranged along the guide direction of the first resonator so that the second section of rectangular waveguide of the first resonator faces the second section of rectangular waveguide of the second resonator, the first section of rectangular waveguide of the second resonator faces the first section of rectangular waveguide of the third resonator, and the second section of rectangular waveguide of the third resonator faces the second section of rectangular waveguide of the fourth resonator; and
the second section of rectangular waveguide of the first resonator is electromagnetically coupled to the second section of rectangular waveguide of the second resonator, the first section of rectangular waveguide of the second resonator is electromagnetically coupled to the first section of rectangular waveguide of the third resonator, and the second section of rectangular waveguide of the third resonator is electromagnetically coupled to the second section of rectangular waveguide of the fourth resonator.

12. A group of resonators for use in a rectangular waveguide filter, the group comprising a first resonator and a second resonator according to claim 7,
wherein the guide directions of the first and second resonators are aligned with each other and the first resonator and the second resonator are arranged along a guide direction of the first resonator;
wherein the second resonator is rotated with respect to the first resonator by 180 degrees around a rotation axis extending in the width direction;
wherein the second section of rectangular waveguide of the first resonator faces a part of the first section of rectangular waveguide of the second resonator and the second section of rectangular waveguide of the second resonator faces a part of the first section of rectangular waveguide of the first resonator; and
wherein the second section of rectangular waveguide of the second resonator is electromagnetically coupled to the first section of rectangular waveguide of the first resonator and the second section of rectangular waveguide of the first resonator is electromagnetically coupled to the first section of rectangular waveguide of the second resonator.

13. The group of resonators according to claim 12, wherein the first resonator and the second resonator are further arranged so that, when seen in a viewing direction extending along the height direction, the second section of rectangular waveguide of the first resonator overlaps with the second section of rectangular waveguide of the second resonator.

14. A group of resonators for use in a rectangular waveguide filter, the group comprising first through fourth resonators according to claim 7,
wherein the guide directions of the first through fourth resonators are aligned with each other and the first through fourth resonators are arranged along a guide direction of the first resonator;
wherein the second and fourth resonators are rotated with respect to the first and third resonators by 180 degrees around rotation axes extending in the width direction;
wherein the second section of rectangular waveguide of the first resonator faces a part of the first section of rectangular waveguide of the second resonator, the second section of rectangular waveguide of the second resonator faces a part of the first section of rectangular waveguide of the first resonator, the second section of rectangular waveguide of the third resonator faces a part of the first section of rectangular waveguide of the fourth resonator, and the second section of rectangular waveguide of the fourth resonator faces a part of the first section of rectangular waveguide of the third resonator; and
wherein the second section of rectangular waveguide of the second resonator is electromagnetically coupled to the first section of rectangular waveguide of the first resonator, the second section of rectangular waveguide of the first resonator is electromagnetically coupled to the first section of rectangular waveguide of the second resonator, the second section of rectangular waveguide of the fourth resonator is electromagnetically coupled to the first section of rectangular waveguide of the third resonator, the second section of rectangular waveguide of the third resonator is electromagnetically coupled to the first section of rectangular waveguide of the fourth resonator, and the first section of rectangular waveguide of the second resonator is further electromagnetically coupled to the first section of rectangular waveguide of the third resonator.

15. A rectangular waveguide filter comprising at least one resonator according to claim 1.

16. A rectangular waveguide filter comprising at least one group of resonators according to claim 9.

17. A rectangular waveguide filter comprising at least one group of resonators according to claim 10.

18. A rectangular waveguide filter comprising at least one group of resonators according to claim 11.

19. A rectangular waveguide filter comprising at least one group of resonators according to claim 12.

20. A rectangular waveguide filter comprising at least one group of resonators according to claim 14.
